(19) United States
(12) Patent Application Publication
(10) Pub. No.: US 2003/0101086 A1
(43) Pub. Date: May 29, 2003

(54) Decision tree software system

(76) Inventor: Gregory San Miguel, Dulwich Hill (AU)

Correspondence Address: PILLSBURY WINTHROP, LLP, P.O. BOX 10500, MCLEAN, VA, 22102, US

(21) Appl. No.: 10/301,572

(22) Filed: Nov. 22, 2002

(30) Foreign Application Priority Data
Nov. 23, 2001 (AU) PR 9070

(51) Int. Cl. G06F 17/60

(52) U.S. Cl. 705/9

(57) ABSTRACT

A method of increasing the compliance level and management of a plan of action, the method comprising the steps of: (a) providing an interactive browser environment for users associated with the plan of action to undertake an analysis of a corporation's policies, laws, regulations or standards associated with the operation environment for the plan of action, and (b) providing via the browser a series of questions and associated information directed to a corporation's policies, laws, regulations or standards associated with the operation environment for the plan of action. Preferably, the method also includes the step of providing a task setting mechanism within the browser environment for setting of tasks for completion by uses associated with the plan of action.

### FIELD OF THE INVENTION

The invention described herein relates to software applications for use as a tool in providing products and/or services in accordance with a required and/or structured format, and typically where in providing the products and/or services it is necessary to refer to voluminous and/or complex information.

### BACKGROUND OF THE INVENTION

In the provision of many products and services, it is often necessary to comply with certain standard process requirements, eg legal or quality assurance requirements. The path to be navigated through the specified requirements will vary depending on the particular project at hand.

Various tools and systems have been proposed for project management. Unfortunately, these systems tend to operate in a standalone manner, providing stand alone project management, training, compliance, reference and other tools and processes. This gives rise to limitations including duplication; increased risk of oversight of applicable requirements and information; inefficient and inadequate communication and sharing of information; incomplete and inadequate records and reports of projects.

### SUMMARY OF THE INVENTION

In accordance with a first aspect of the present invention, there is provided a method of increasing the compliance level and management of a plan of action, the method comprising the steps of: (a) providing an interactive browser environment for users associated with the plan of action to undertake an analysis of a corporation's policies, laws, regulations or standards associated with the operation environment for the plan of action, and (b) providing via the browser a series of questions and associated information directed to a corporation's policies, laws, regulations or standards associated with the operation environment for the plan of action. Preferably the method also includes the step of: (c) providing a task setting mechanism within the browser environment for setting of tasks for completion by uses associated with the plan of action.

The series of questions can include a series of structured checkpoint questions posed in the interactive browser environment for asking a series of checkpoint questions about the plan of action, the checkpoint questions identifying various legal and regulatory issues that may impact on the plan of action. First predetermined members of the series of questions can have associated interactive advisory prompts for users to review in answering the questions and second predetermined members of the series of questions have associated interactive task creation facilities for creating tasks associated with the questions for users of the system to perform. The task creation facilities can include task designation and sign off capabilities for assigning tasks to users and ensuring their completion.

Preferably, the system also includes the step of providing a task reporting facility for reporting allocated tasks associated with a project and the step of storing substantially all the user's interations with the system for future reference of procedural compliance.

In accordance with a further aspect of the present invention, there is provided a computer based interactive training system for just in time training of individuals involved in a currently active project, the system including: (a) an interactive user interface; (b) questioning means for asking an interactive series of questions through the user interface, with the user's answers recorded by the system and determining what future questions may be asked by the system with predetermined members of the series having associated background information on compliance issues associated with the question.

Preferably, the system also includes task setting means for task setting capabilities for setting and monitoring tasks for completion by users of the system. The series of questions are preferably directed to a corporation's policies, laws, regulations or standards and the system acts to increase compliance with the corporation's policies, laws, regulations or standards. The system can be implemented utilising Web Browsers and XML and XSL documentation standards. Ideally, different users have different capabilities in the setting of tasks for other users. In one embodiment, substantially all user interactions with the system are preferably stored for future reference of procedural compliance.

In accordance with a further aspect of the present invention there is provided a software system for aiding in the navigation of a project path. The invention resides in a system comprising: a question database; a response database; a user interface; one or more applications; wherein said question database stores a plurality of system questions; wherein an application comprises a structured decision tree of questions from said question database; wherein said user interface provides a selected application to an authenticated user; wherein a user is able to create a project through said interface, said project comprising a plurality of user provided responses to the questions of an application; and wherein said user provided responses are stored in said response database.

Preferably, a project contains references to standard answers stored in the response database. Preferably, if a user provided response to a question does not exist within the response database, the system writes the new response into the database and stores a reference to the response within the project, otherwise, a reference to the existing response is stored within the project.

Preferably the system further includes a reference database containing reference data, wherein an application contains one or more links to reference data in said reference database that is relevant to the application, said links being selectable by the user through the interface to cause said user interface to display said selected reference data.

Preferably the system further includes an administration interface through which an administrator may alter content of the system.

In one preferred embodiment, each application decision tree comprises one or more sections selectable by an authenticated user through the user interface, each section comprising one or more subordinate pages, each page comprising one or more questions from said question database, wherein pages are presented through the user interface in a sequential order according to a control logic dependent upon user provided responses to page questions. In a further preferred embodiment, a page may contain a hyperlink to reference material relevant to the content of that page.

The preferred embodiment is able to bring together into one, process administered by a non-lawyer with the ability to:

a. undertake a substantive legal/regulatory review or ‘vetting’ of a document, plan or output; and identify the legal and regulatory issues that impact on it, as a ready and rapid concomitant of their commercial activity

b. immediately respond to and action those issues by the advisory prompts and information stored within the system, or by fast task allocation or inquiry to other stakeholders

c. manage the action points to completion and closure. This is a function of collaborative input from stakeholders, the task allocation system and the Report function

At the same time the entire user interaction is stored and may be audited for evidentiary purposes, with the added benefit of a Project and Document history trail (by user/date/time/version etc.) The User is armed with all they need to learn about and address in terms of legal and regulatory impacts, as a seamless part of their process. This allows for a hyper-efficient information tool, providing impacts on risk reduction and management, time and cost savings and enhanced productivity.

The preferred embodiment also provides a ‘just in time’ training tool and has the (unexpected) benefit of training a user with information provided rapidly, as needed, in context, and permitting the user to apply that information immediately to a live current activity so as to manage their own and other stakeholders' behaviours effectively, with no prior training or input at all. The preferred embodiment also provides the combination of a decision pathway, access to relevant information and a workflow tool that enables companies to implement policies, laws and regulations and establish standards that may be systematically enforced, monitored and measured.

With the preferred embodiment it is difficult for a user to proceed to completion without reaching an informed judgment as to an appropriate course of action, and for that judgment to be made transparent by virtue of interaction with the system. In other words it makes subjects learning, decision-making and action-taking accountable.

### BRIEF DESCRIPTION OF THE DRAWINGS

The invention will now be described by way of example only with reference to preferred embodiments and to the following figures in which:—

FIG. 1 shows Administration and User Interface component interactions;

FIG. 2 shows Information structures in a System according to the invention;

FIG. 3 shows User Interface structure with the interface in open state;

FIG. 4 shows accessing the User Interface;

FIG. 5 shows an authentication process for requests to the User

FIG. 6 shows a sample layout for the application-welcome screen

FIG. 7 shows a sample layout for the application-new-project screen;

FIG. 8 shows a sample layout for the application-project-menu screen;

FIG. 9 shows a sample layout for the application-document-menu screen;

FIG. 10 shows a sample layout for the application-new-document screen;

FIG. 11 shows a sample layout for application-page screen, showing question screens;

FIG. 12 shows a sample layout for application-question-mcq screen;

FIG. 13 shows a sample layout for application-question-text screen;

FIG. 14 shows a sample layout for application-revisions-menu screen;

FIG. 15 shows a sample layout for application-revisions-compare screen;

FIG. 16 shows a sample layout for application-revisions-documents screen;

FIG. 17 shows a sample layout for administration-menu screen; and

FIG. 18 to FIG. 25 illustrate various screen dumps for the interactive task management system of the preferred embodiment.

### DETAILED DESCRIPTION OF THE EMBODIMENTS

The preferred embodiment of the present invention provides a software system for allowing and/or aiding in:

1. the definition and development of standard process requirements, and the way in which those requirements should determine the project path required for a particular project

2. the integration and consolidation of standard process requirements relevant to a particular project or class of projects

3. the timely, in context, provision of relevant background, precedent and/or reference information to users to allow them to correctly answer questions and make elections which the system uses to determines the appropriate project path for a project

4. the generation of the appropriate project path for a project

5. the navigation of a project path

6. the collaboration of multiple people involved in a project

7. the monitoring and recording of the actual navigation of project paths for projects in a way which facilitates future searching, modification, use and archiving of records.

The combined features of the system of the preferred embodiment produces an intelligent project and information management application which provides users with relevant information at the time it is required, and which generates a project path customised to the particular project. This overcomes various limitations of stand alone project management, training, compliance, reference and other tools and processes. These limitations include duplication; increased risk of oversight of applicable requirements and information; inefficient and inadequate communication and sharing of information; incomplete and inadequate records and reporting of projects.

The preferred embodiment of the present invention achieves the above and other functionality by providing various new features associated with project management, information management and other processes. These features may be implemented individually, or in appropriate combinations. The features include:

1. The presentation of questions to the user based on the control logic of a decision tree structure. The user's responses to previous questions determine which subsequent questions will be presented (and which questions determined to be unnecessary will be omitted). In this way the system determines a project path suited to the particular project and limits the number of irrelevant issues and procedures which the user is required to consider and follow. References to ‘questions’ include directions or other statements presented by the system to users. Equally references to ‘answers’ and ‘responses’ includes any information entered by users in response to these questions, directions and statements.

2. The presentation to users of relevant background, precedent, reference and/or other information in a manner determined by the control logic of the decision tree structure. For example, to allow a user to answer a question in an informed manner the software system may present the user with technical information relevant to the question's subject matter. Another example is the presentation to the user at an appropriate time of precedent information or forms which may assist the user's execution of the project at that stage. In this way the system integrates relevant information with standard project processes, presenting information to the user in context and at an appropriate time. This limits the amount of unnecessary information which the user needs to consider and maximises the prospect of effective assimilation and use of the information by the user for the purpose of the project.

3. Making available to users documents and information which are relevant to the particular Project (‘working documents’). The system allows users to add and modify working documents. For example, where the Project is a marketing campaign, the working documents may include the content of the proposed campaign including advertising copy, images and launch schedule. The working documents may be easily viewed and revised in a frame alongside the questions, answers and information referred to in the preceding features and which are included in another frame. The user can simply navigate and drag and drop content between the frames.

4. Individual or groups of users to be granted different access and modification rights for individual or groups of projects. These rights may include the following types of rights:

rights to answer questions

rights to add working documents

read only rights

modification rights where the user may modify answers and documents added by other users

administration rights which may include some or all rights to change other users and their rights, modify question content and their logical structure, view logs of user activity and historical records of project paths.

This feature facilitates efficient collaboration where multiple people are assigned to a project. The system provides a central repository of project information available for access by users according to their access rights. This facilitates efficient and effective information sharing and communication. This feature also allows the system to embody the hierarchies and rules of collaboration between project team members.

5. The preferred embodiment facilitates the use of the system as an operations and project management tool. Administrators may embody standard processes in the system by using the features described above which allow the intelligent presentation of relevant questions and information to users. For example, if a particular condition must be met before a project may proceed, the user can be asked whether that condition has been satisfied. If the condition has not been satisfied, the user may be provided with details of the actions required to procure that satisfaction. Until the user confirms satisfaction of the condition, the user may not be permitted to proceed with subsequent questions in the project path. Another operations and project management feature is the integration of automatic or assisted email communications with other participants in the project path. For example, if the condition referred to in the preceding example is receipt of an approval from a particular person, the system may generate an email to that person seeking that approval. This email may include the required format of the person's approval, and the user may need to certify receipt of the required approving email before proceeding with subsequent questions in the project path. Alternatively the person may be required to record their approval by responding to a question allocated to them in the project path. Where there is a hierarchy of approvals required, the system allows escalation of approval requests—when one approval is given, the system may generate a further email seeking the next level of approval.

6. The assignment of tasks by a user to other users. For example, a user may assign a question to another user and use an email generated by the system for this purpose. The system records and tracks these task assignments.

7. The generation of a list of all current projects with specified project details (for example, the date of last modification). An administrator may access any of the projects for full project information via links in the project list.

8. The creation and processing of scheduled events.

9. Another feature is the ability to use the control logic of the decision tree structure to enforce adherence to process requirements. For example, the system may prevent a user proceeding with further questions in the jungle path unless a particular question is answered appropriately.

10. Another feature involves flexible reporting of the status and results of a project, with the ability to customise the form and content of the report. For example, a user can prepare a report listing the answers to some or all questions which can be used to provide project information to other people or for audit purposes. The reports can include project information within a pro-forma document, for example to generate a form of request for service or advice from a third party (e.g. a request for legal advice). This assists the efficient and proper briefing of users and third parties with relevant information.

11. Another group of features enable the recording and tracking of different stages of the navigation of the project path for a project, and the history of users' participation in that navigation. Each time new content is added, or existing content is modified, the original version is stored along side the modifications. The multiple versions are used to allow tracking of revision histories and to enable users to revert to any version of a project to a previous version if required. The information recorded can include:

logs of all user sessions

all versions and revisions of working documents, with the ability to restore a prior version of a working document

all responses entered by users, including details of the user and user session

emails, task allocations and event schedules.

12. Another recording and tracking feature enables the efficient review for each question of the different answers to that question which have been given by different users or by the same user in different sessions. A user with appropriate rights can review together all answers to a question or selected questions (together with details of the user and date and time of the session in which the answer was given), and the user can choose to restore a superseded answer as the current answer by simply selecting that superseded answer. The system is able to maintain a complete record of the project at different times throughout the period of the project, and make these records readily accessible. This provides an audit trail which reveals not only the final outcome of the project path but also a history of the way in which the project was carried out and provides a comprehensive and centralised record of the different aspects of implementation of the project, removing the need to refer to multiple stand alone project management, training, compliance, reference and other tools and processes. Also, information is readily available in an appropriate form for the purposes of demonstrating adherence to proper processes and for use in subsequent inquiries or issues including legal disputes or actions. Responsibility of different users for different aspects of the project is also tracked. Also, supervisors are able to monitor progress and the involvement of different users in the project during the course of the project. The system allows supervisors to review user answers and working documents and changes to them, and facilitating the restoration of prior answers and documents where considered appropriate.

13. Certain users to use the system to develop and define standard process requirements for different types of projects. This feature arises from the ability of designated users with appropriate rights to change the content and logical structure of questions, as well as to change users and their access and modification rights. These operations and project management features facilitate integration of the system into the operations, workflows and other processes applicable to users.

By way of example, the description of the preferred embodiment will proceed by describing an embodiment of the software system to assist in the process of development and approval of marketing proposals in a way which complies with legal, industry and other external requirements, as well as the internal requirements of the entity undertaking the marketing. This process has the following features which make it suitable to illustrate the benefits of the system:

marketing activity is heavily regulated. This regulation is often complex, and the requirements differ according to factors like type of marketing activity, type of product or service, geographic location and type of consumer

marketing activity is heavily scrutinised by regulators, consumers and competitors. It is important to be able to demonstrate compliance with legal and other requirements and processes

marketing projects typically require collaboration between a number of different people with different roles and skills

marketing projects typically have fixed and tight deadlines requiring effective project management.

Examples of the application of the system's features and benefits to this embodiment are:

the presentation of questions and information to the user is dictated by the type of marketing activity. For example, the user may be asked whether the activity involves the offer of a reward or prize, and whether there is an element of chance involved in winning it. If the user answers yes to these questions, the user may be presented with information about requirements for permits under lotteries and gaming law, as well as questions to guide the user through the steps required to obtain necessary permits. Similarly the presentation of questions and information to the user may be dictated by the type of product or service being marketed, or the consumers being market to.

the presentation of relevant internal process requirements and precedents to users. For example, when developing print marketing for a particular product the user may be presented with relevant disclaimers and logos required to be included.

the generation of a request to internal or external lawyers for approval of the marketing activity. The form of request generated may incorporate user answers and working documents. This facilitates efficient and complete briefing of the lawyers as the format of the request and relevant questions have been designed with this function in mind. More generally the system, by posing appropriate questions and presenting information in context requires non-lawyer users to consider relevant legal issues as they are developing the marketing proposal. This minimises the risk of refusal of legal approval, and the requirement for extensive revision of the marketing proposal. This process can be contrasted with a more traditional procedure where marketing materials are developed by non-lawyers without the benefit of targeted information provided to them in context. The more traditional procedure leaves the legal vetting process to the final stages of the marketing project, increasing the risk of legal impediments being identified at the stage and requiring a substantial reworking of the marketing proposal. In contrast the system empowers non-lawyer users in their development of marketing proposals by presenting them with targeted legal information in context and in an appropriate form.

the simple navigation between the working documents and the questions, answers and other information recorded by the system. This facilitates the manipulation of marketing content in accordance with applicable marketing process requirements.

Technical Assumptions

The preferred embodiments described below are based on the following design decisions and/or assumptions, though it will be apparent to the skilled addressee that other design parameters are possible. However, the skilled address is assumed to be fully familiar with the systems and terminologies utilised.

(a) XML Used for Content Description

The standard extendable markup language XML has been chosen as the means of defining content such as questions and decision tree structure. XML has been chosen for its flexibility and growing acceptance as a standard for describing data. Full details on XML can be found at www.w3.org.

(b) XSLT Used for Interface Format Descriptions

In conjunction with XML for content, XSLT can be used to specify the format (‘look and feel’) of user and administration interfaces. This allows for very flexible customisation of interfaces, although it will require some training in XML and XSL to maintain. Full details on XSLT can be found at www.w3.org

(c) World Wide Web Used for Interface

All of the user functions can be accessible from a standard Web browser (Netscape 4.0 or Internet Explorer 4.0 or above). Some advanced administration can be achieved by maintenance of a file system on the Web Server. Much of the web interface can be presented using HTML forms and data will be transferred from the user to the application using HTML form elements.

(d) SQL DBMS Used for Storing User Profiles

To enable easier and more flexible access to user data, and potentially allow integration with third party databases, the system is designed to store information about users and user profiles in an SQL92 compliant Database Management System.

(e) SQL DBMS Used for Storing Responses

To enable easier and more flexible access to user answers, and potentially allow integration with third party databases, the system can be designed to store information about users' answers to question in an SQL92 compliant database. Note that the question content and structure may not be stored in a database, but instead in an XML document.

(f) Java Servlet Framework Used as a Server Platform

The system can be built using Sun's Java Servlet Framework (JSDK 1.2). Java has been selected as a platform because of its unparalleled portability, standardised nature and ease of customisation and maintenance. Furthermore, current frameworks allow Java Servlets to operate very efficiently and ease the task of database integration.

Components Overview

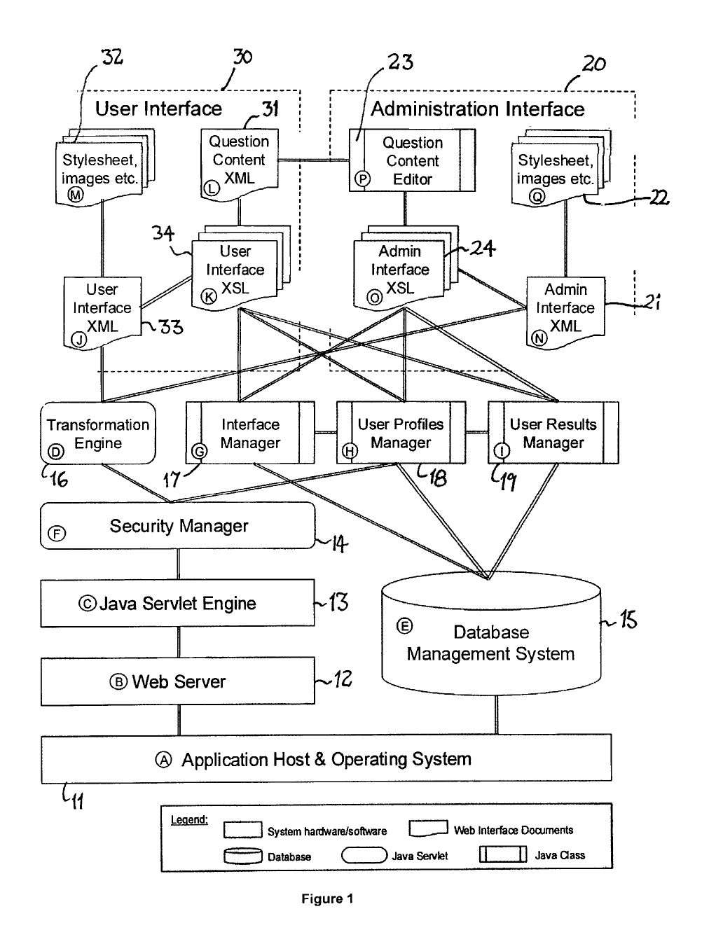

This section outlines the major components required in this specification. Components developed for the purpose of the preferred embodiment are based upon the system requirements described immediately below, which system requirements are provided for the purpose of a non-limiting illustration only. These requirements are to be fulfilled by the installation of existing third-party software. Included in the following list are recommended software applications for each component. These components are represented graphically in FIG. 1. The interactions among the components are described later.

Third-Party Components (System Requirements)

These third-party components are required in order for the application to be installed and operated:

Application host—a computer required to act as an application server (IBM PC-compatible server recommended)

Operating system—required to execute application software (Linux recommended).

Web server—required to provide Internet or Intranet access to the web-based interfaces (Apache Web Server recommended).

Java servlet engine—required to enable Java servlet functionality (Jakarta-Tomcat servlet engine recommended).

XML transformation engine—required to enable XML and XSLT transformations in conjunction with a Web Server (Cocoon/Xalan recommended).

SQL Database management system—required to store and retrieve user profiles and data via SQL92 queries (MySQL recommended).

Third-Party Component Interactions

These interactions take place at a relatively low level and do not impact greatly on the software application of the preferred embodiment. It is however important to be aware of the roles they each play in the operation of the application.

A. Application Host and Operating System (11)

This component comprises the computer hardware, infrastructure and operating system on which all other software is installed and executed. In terms of the construction of the application, the operating system and hardware used is not important, provided it is capable of supporting standard TCP/IP internet communications and running a Web Server 12 and a Java Servlet Engine 13. At the lowest level, the Application Host 11 is responsible for interfacing with the network infrastructure and providing an operating system on which the Web Server 12 and Database Management System 15 can reside.

B. Web Server (12)

The Web Server 12 is responsible for handling an http requests to the Application Host 11 and correctly passing the request on to the Java Servlet Engine 13 for further processing. After processing, the Web Server 12 will prepare an http response to return to the end user. In the application, the Web Server 12 itself does not play a major role other than forwarding requests and responses to the Java Servlet Engine 13.

C. Java Servlet Engine (13)

The Java Servlet Engine 13 is required to support Java Servlets. It is usually installed and configured as an additional module to the Web Server 12. The Java Servlet Engine 13 is responsible for handling a request for a java servlet, locating, loading, initialising and invoking methods in java servlets. The Java Servlet Engine 13 is required for the XML Transformation Engine 16 and to support the application's Java components, to be described in following sections.

D. XML Transformation Engine (16)

The XML Transformation Engine 16 is normally implemented with an API using a Java Servlet, and so requires a Java Servlet Engine 13 to support it. The Transformation Engine 16 is responsible for taking XML and XSL documents, and generating output that transforms the XML contents according to XSL instructions. The transformation engine 16 must be capable of supporting http-style parameters.

E. Database Management System (15)

The Database Management System 15 is required as the foundation for other components that require the ability to store and retrieve particular information in an efficient and reliable manner. The database has no meaningful interactions with other third-party components. It will be utilised by the application's Java and XSL components, described in following sections.

Java Components

The following components are constructed specifically for the application. They are each built as Java classes in a modular fashion to form underlying back-end functionality that will be utilised by the user and administration interfaces.

Interface Manager (17)—a java class for managing various tasks required by other components and for processing events that can be scheduled by users of the system. E.g. a user can automatically notify a colleague via email that they have completed an operation.

Security Manager (14)—a class implementing the Java Servlet API, responsible for ensuring that access is only granted to authorised persons. All requests to the web interface actually pass via the Security Manager 14 for authorisation. This involves checking a user id and password against a database and issuing time-limited access keys for the web interfaces.

User Profiles Manager (18)—a class that acts as an interface between other components and the User Profiles Database. The User Profiles Database stores information about authorised users and what areas of an application they are authorised to access. This class is queried for information in the database rather than providing direct access to the database so that particular details of database management can be hidden from the other components. This will make it easier to modify functionality to suit other database systems in future if required.

User Results Manager (19)—like the User Profiles Manager 18, this class acts as an interface between other components and the User Results Database. The User Results Database stores information about how users have answered questions.

Java Components Interactions

F. Interface Manager (17)

The Interface Manager 17 is a class that handles various minor tasks required by components of the system (such as reading from the Application Host file system), and for creating and processing scheduled events. Normally, scheduled events will be sending notification messages to one or more users of the software, or appending data to a log file. For example, a supervisor may schedule a notification to be sent to all subordinates on a certain date. The Interface Manager 17 will receive a request to schedule a new event from other components of the system and will store events in a database. When the Interface Manager 17 is instantiated it spawns a Thread to regularly check whether any scheduled events are ready for processing. If so, the event is processed and removed from the database. Other functions provided by the Interface Manager 17 include reading from files and writing to files in the Application Host's file system.

The Interface Manager 17 requires the Database Management System 15 to store information. Different implementations of the Interface Manager 17 may be created for different Database Management Systems 15 if necessary.

G. Security Manger (14)

The Security Manager 14 is responsible for ensuring that a user is authorised to access particular parts of the application. The Security Manager 14 is a Java servlet and thus requires the Java Servlet Engine 13 to operate. It also works with data about users and their permissions in a User Profiles database, which is accessed via the User Profiles Manager 18 component. When a user first attempts to access protected material, they must first enter a user name and password to gain access. If their details are found in the User Profiles database they will be issued with a unique and time-limited session key that provides them with access to those areas of the application that are defined in their user profile. All requests to the web interface are effectively made via the Security Manager 14, which has a chance to vet requests prior to accessing content.

H. User Profiles Manager (18)

The User Profiles Manager 18 acts as an interface between software components and the Database Management System 15 via an API comprised of public static class methods. It is used primarily by the Security Manager 14 to retrieve information about user profiles when determining whether access ought to be granted to the web interface. Different implementations of the User Profiles Manager 18 may be created for different Database Management Systems 15 if necessary.

I. User Results Manager (19)

The User Results Manager 19 provides an interface between software components and the Database Management System 15 via an API consisting of public static class methods. Different implementations of the User Results Manager 19 may be created for different Database Management Systems 15 if necessary.

XML User Interface Components

The following components are comprised of XML and XSL documents. They are used to construct the web based User Interface 30 (as opposed to the Administration Interface 20). The XML documents contain content from the User Interface (instructions, page titles, etc.) and contents of question data and structure. The XSL contains XSLT instructions and logic to control the presentation of interface elements and data. Other resources (such as stylesheets and images) are used to enhance the appearance of the interface.

User Interface XML (33)—this consists of a single XML document that contains the entire user interface structure and information (such as prompts and instructions). It is used for presenting questions and other information (the content of which is drawn from another document).

User Interface XSL (34)—this consists of one or more XSL documents that contain the instructions for drawing question content from the Question Content XML 31 and presenting it along with the elements of the User Interface XML 33 document. The XSL will also contain logic for determining the user's path through the decision tree structure and for storing user responses in the User Results Database.

Question content XML (31)—this document contains the source data for all questions in the application and their structure.

Stylesheets, images etc (32)—these are miscellaneous other resources used in the presentation of the web interface.

XML User Interface Components Interactions

The interactions among the User Interface XML components are described below and represented in FIG. 1.

J. User Interface XML (33)

The User Interface XML 33 consists of a single XML document that contains the entire User Interface for presenting questions and other information to the user. The User Interface XML 33 requires the XML Transformation Engine 16 to perform the necessary transformations from XML to XHTML in the generation of interface elements. The interface includes references to miscellaneous resources (stylesheet, images, etc). The interface interacts with the User Interface XSL 34 in that the XSL contains instructions and logic on how to present the User Interface XML elements.

K. User Interface XSL (34)

The User Interface XSL 34 is the central part of the User Interface, in that it embodies the critical functionality of the user interface. It is first responsible for taking the information in the User Interface XML 33 and providing instructions on how to transform the XML elements to XHTML ready for despatch to a client web browser. It is also responsible for determining and then drawing relevant question content from the Question Content XML 31 file, based upon the user's current position in the decision tree and their previous responses to questions. In determining the relevant question content for the user, the XSL will interact with the User Results Manager 19 in order to store and retrieve responses to questions. The XSL 34 will also be able to interact with the Interface Manager 17 as an interface to the Application Host 11 and for scheduling events (such as sending a notification email when a particular milestone has been reached in the program).

L. Question Content XML (31)

This is an XML file that contains the content of questions, and represents the structure of the questions within the decision tree, including logic for determining a user's path through the decision tree dependent on their responses to questions. This XML is used by the User Interface XSL 34 when generating the web based user interface.

M. Stylesheet, images, etc. (32)

These miscellaneous items are used to enhance the visual appearance of the web interface. They are referred to in the User Interface XML 33 document.

XML Administration Interface Components

The following components consist of XML and XSL documents. They are used to construct the web based administration interface 20 that provides functionality to create and manage question content and appearance of the user interface. The documents required are:

Administration Interface XML (21)—this consists of a single XML file that contains all the content elements used in the presentation of the web interface for administration of the software.

Administration Interface XSL (24)—this consists of one or more XSL documents that contain all the logic, instructions, and integration with other components required to present the content of the web interface and give effect to actions performed via the interface.

Question Content Editor (23)—this is a Java class used to edit the contents of the Question Content XML 31 file in order to manage question structure and contents.

Stylesheet, images, etc. (22)—these are miscellaneous other resources used in the presentation of the web interface.

XML Administration Interface Components Interactions

The interactions among the Administration Interface components are described below, and depicted schematically in FIG. 1.

N. Administration Interface XML (21)

This is comprised of a single XML document that contains the contents of the entire administration interface 20 used for creating and managing questions, question structure, and the User Interface 30. The document requires the XML Transformation Engine 16 to transform the XML elements into XHTML, in conjunction with the Administration Interface XSL 24. The interface will also include references to images and a stylesheet to enhance the visual appearance of the application.

O. Administration Interface XSL (24)

The Administration Interface XSL 24 is the central part of the Administration Interface 20, in that it enables its critical functionality. It is first responsible for using the information about interface elements in the Administration Interface XML 21 file and providing instructions on how to transform the elements into XHTML ready for despatch to a client browser. It is also responsible for receiving requests from the user interface 30 to perform actions and for then carrying out those actions via other components. The other components with which the XSL actively interacts are:

Interface Manager 17—the Interface Manager 17 provides a number of miscellaneous functions for interacting with the Application Host 11, including most notably, scheduling messaging events;

Security Manager 14—access to the interface requires secure login;

User Profiles Manager 18—the interface can be used to add, remove or modify user profiles;

User Results Manager 19—the interface can be used to access and manage user results;

Question Content Editor 23—the interface offers the ability to create and manage questions in an application.

P. Question Content Editor (23)

The Question Content Editor 23 is a Java class that provides functionality to the Administration Interface XSL 24 allowing for editing of question structure and content. It thus interacts with both the Administration Interface XSL 24 and the Question Content XML 31 document.

Q. Stylesheet, images, etc. (22)

These miscellaneous items are used to enhance the visual appearance of the web interface. They are referred to in the Administration Interface XML 21 document.

System Specifications

This section sets out detailed specifications for the System. It is organised around conceptual entities and functionalities rather than by software components, in order to aid in understanding of how the software will actually operate. However, concepts and functionality are linked to the components set out in the Component Overview.

Definitions

For the sake of clarity, throughout the remainder of the present description, the following terms will be used in the context of the respective definition attributed thereto, however, it will be understood by the skilled addressee that in its broadest form, the present invention may not be limited to the definitions provided herein.

Administration Interface—a web based interface to the System that allows an authorised user to create and manage content in the System, and to access User Results.

Administrator—an individual who is authorised to access the Administration Interface for an Application.

Application—a self-contained set of questions and associated resources within a decision tree structure. Within the System there can be multiple Applications.

Application Host—the computer hardware acting as a Web Server, onto which the software in the System is installed.

Applications Directory—a file system directory under which each Application has a subdirectory. Content files for each application (e.g. XML and XSL documents) are stored in subdirectories under the Applications Directory. See also Application Files Directory.

Application Files Directory—each Application has its own subdirectory under the Applications Directory. The name of the Application Files Directory is the same as the Application's name.

Developed Software—refers to the components of the System that have been provided or developed specifically for the System. It excludes Third-party Software, but includes the Servlet Components (except the XML Transformation Engine), XML User Interface Components, and XML Administration Interface Components.

Servlet Components—Java Servlet software components that form part of the System, as set out in the Components Overview section of this document.

Software—all software residing on the Application Host, including the host operating system, Web Server, and Developed Software.

System—the entire entity described in this specification, including hardware, software and infrastructure.

Third-party Software—software provided by third parties, such as operating system, Web Server, etc. as set out in the Components Overview section of this document.

User Interface—a web based interface to the System that allows an authorised user to access and answer questions that have been created via the Administration Interface.

User Group—a group of users that share access rights to information in the System. Each application will normally have at least one group for Administrators and one group for Users.

User—an individual who is authorised to access the User Interface to view and answer questions in an Application.

User Results—when a User accesses the User Interface their answers to questions are collectively referred to as User Results.

User Results Database—User Results are stored in a User Results Database in the Database Management System.

XML Administration Interface Components—primarily XML-based components, used to generate and present the Administration Interface, as set out in the Components Overview section of this document.

XML User Interface Components—primarily XML-based components, used to generate and present the User Interface, as set out in the Components Overview section of this document.

Information Structures

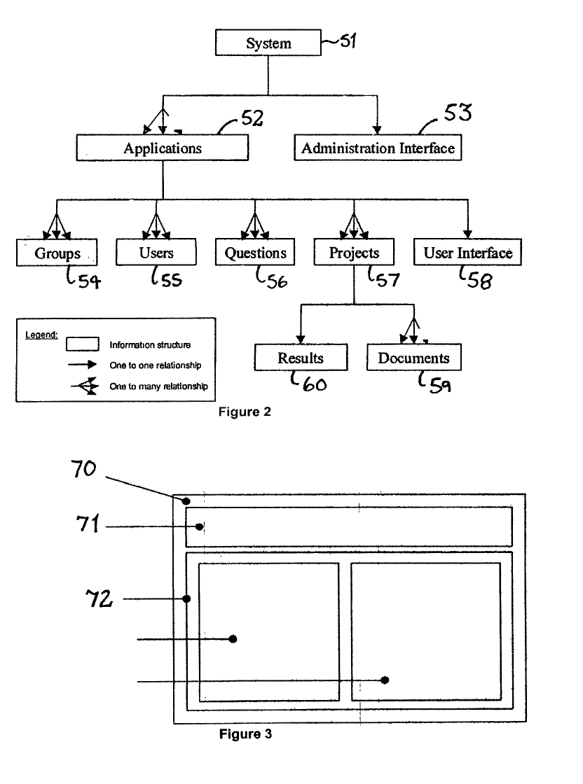

This section of the document gives a concise overview of the types of information structures used within the System and how they are used. Referring to FIG. 2, from most general to most specific, the major information structures are: the System 51, Applications 52, Groups 54, Users 55, Projects 57, and Documents 59. These are each described in the following subsections.

Standard Naming Requirements

Where an information structure, including database and file system structures, has a name component, the name must conform to standard naming requirements. An exemplary set of naming requirements is as follows:—

Allowed Characters

Names must consist only of the following character types:

Letters of the alphabet, included accented characters

Numerals

Spaces

Hyphens

Underscores

Apostrophes

Commas, semicolons, or colons

Length

Names must contain no less than 2 characters and no more than 64 characters.

Case Sensitivity

Names are case-sensitive.

System 51

The System 51 is the highest level of structured information. All other information is conceptually embodied within a System.

Administration Interface 53

Each System 51 contains exactly one Administration Interface 53, which is a web interface to administer Applications 52 within the System 51.

The Administration Interface 53 provides functionality for creating, viewing and managing other information structures within an Application 52.

Although there is only one Administration Interface 53 for each System 51, the interface is always accessed in the context of an Application 52, so the Administration Interface 53 effectively has an Application scope.

Applications 52

Each System 51 comprises one or more Applications 52.

An Application 52 is a self-contained set of questions and associated resources within a decision tree structure. Multiple Applications 52 can be used concurrently in a single System 51 to allow for multiple User Interfaces 58 and content sets to be presented to different groups of users.

Each Application 51 must have a name that follows the Standard Naming Requirements and which is unique within a System 51.

Groups 54

Within each Application 52, there can be one or more Groups 54. A Group is a collection of Users 55, which makes it convenient to perform operations on multiple users.

Groups 54 can be related via the concept of “Supervisors”. That is, one group can be set as the supervisor of another group, giving the supervising group special privileges to access and modify the work of the supervised group.

It is usual to create at least two groups within each Application 52—the first for general users, and the second for supervisors.

Each Group 54 must have a name that conforms to the Standard Naming Requirements and is unique within an Application 52.Users 55

Within each Application 52, there can be one or more Users 55. A user represents an individual who has been given some privileges to access the Application 52 via the User Interface 58.

Users are said to “belong” to Groups 54, but it is a many-to-many relationship, so the User structure is not strictly subordinate to the Group structure.

Each User 55 must have a name that conforms to the Standard Naming Requirements and is unique within an Application 52.

Projects 57

In addition to Users 55 and Groups 54, each Application 52 can contain one or more Projects 57. A Project 57 represents a complete or partially complete set of answers to questions presented by the User Interface.

A Project is always owned by a single User 55, however it can be shared by other members of the User's Groups, allowing for collaborative projects to be built.

Work in a Project 57 is saved across sessions, so it is possible for one or more Users to complete a Project over a period of time.

Each Project must have a name that conforms to the Standard Naming Requirements and is unique within an Application.

User Interface 58

Each Application 52 has exactly one User Interface 58. This is a web interface for people to work on a Project 57.

The User Interface 58 presents Questions 56 for an Application and stores the Results 60 when Users provide answers to the Questions.

The User Interface 58 is comprised of User Interface XML, User Interface XSL, Question Content XML and other Miscellaneous Resources.

Because there are multiple copies of User Interfaces, each Application is free to implement its own customised version of the interface.

When a user accesses the User Interface, they will identify which Application 52 they wish to access, and all actions that they perform will be within the scope of the selected Application.

Questions 56

Each Application contains one set of one or more Questions 56.

Questions are structured in a decision tree, and when users access the Questions via the User Interface 58, the path through the decision tree can change dynamically depending upon answers that the user gives.

More detail on how Questions are structured in the Decision tree is available in the section discussing the “title” element.

Results 60

Results are the answers to the Questions 56 given by users within each Application 52.

Each Project 57 (see below) represents one set of Results 60 for the Questions 56 within an Application 52. For each Project 57, there will be a unique set of Results.

Results are stored with multiple versions of content in the database. Each time new content is added, or existing content is modified, the original version is stored along side the modifications. The multiple versions are used to allow tracking of revision histories and to enable Users to revert any version of a Project to a previous version if required.

Documents 59

Projects are usually based around one or more Documents 59, which are simply files containing images and/or text that generally are the subject of questions presented in the User Interface 58.

Revision Tracking Model

Over time, in a collaborative environment, many different Users may contribute to a Project over many separate sessions. This means different results being entered and different documents being uploaded. An important feature built in to the System is the ability to track revisions, for the appropriate Users to be able to view a representation of the revision history for a Project, and if necessary, to return to any previous revisions of a Project.

In order to maintain ease-of-use for the target Users of the User Interface, an automated and non-intrusive model for storing and accessing revisions has been constructed.

The revision model relies on the concept of User Sessions. A User Session can be considered to begin when a User selects a Project to work on in Write mode (that is, with the ability to edit the contents of a Project), and to end when either the User logs out of the Project via the User Interface, or when they are timed out of the System automatically.

It is important to note that Users work on Projects via an exclusive-locks mechanism which ensures that at any time, only one User can be working on a Project in Write mode. This ensures that the revision model does not have to represent multiple simultaneous editions of a Project.

When a User begins a Session on a Project, the System automatically creates a new Revision of the Project. This involves making a copy of the Project's state as it existed at the beginning of the Session. At this point, the Revision is said to be an ‘open revision.’ When the Session ends, the new Revision is said to be a ‘closed revision.’ So, for any Project, the System may actually retain multiple copies of the state of the Project.

Each Revision of a Project stores information about the time the Session began, the user who made the edits, and which items were changed during the Session.

By default, the most recent revision of a Project is accessible.

For Users who are owners of a Project, or for any Supervisors of owners of a Project, a ‘Revision History’ link can be accessed at certain points in the User Interface and these links provide a mechanism to view, compare and/or restore previous revisions.

Results Data Storage Model

In order to store the content of responses as efficiently as possible, a pure referential scheme is proposed for data storage and retrieval. This allows for efficient representation of multiple copies of the same Project, especially in cases where Project Revisions contain incremental edits.

Results in a database are represented by two pieces of information. The first piece of information holds the actual contents of an answer to a question. The second piece of information stores a reference to that data which links the data to a particular Project Revision.

For any individual piece of data representing the content of an answer, there will only ever be one copy of that data in the System. Where the same answer has been given to different questions, or in different Projects, or even in different Applications, there will be one copy of the answer, but multiple references to that data.

With a referential system, the space required to store Results data is minimised, because rather than having multiple copies of content in the system, there will only be multiple references to a single copy of content in the System.

When an answer is submitted via the User Interface, the System first checks to see if that answer already exists in the System. If the answer already exists, then a reference to the existing data is stored for the answer. If the answer does not already exist in the System, then a new copy of the data is stored, and a reference to that new data is stored for the answer.

The System must periodically check the database to find ‘orphaned’ data, that is data for which there are no more references. This data is no longer required in the System and should be deleted so that the database does not grow unnecessarily large.

XML Structures

All interface elements and question contents are stored in XML files. This section details the elements that are stored in the three main XML files used in the System; Administration Interface XML, User Interface XML and Question Content XML.

Administration Interface XML

The Administration Interface XML contains all of the screen structure elements for the Administration Interface, which is provided to enable individuals to manage Applications via a web interface. Each System comprises only one Administration Interface XML, and all Applications are administered by way of the web based interface defined in this file.

Admin-Interface Element

The root element for the Administration Interface XML file is the admin-interface element.

The admin-interface element defines an entire administration interface, and contains all other elements within the XML file.

The admin-interface element takes no attributes.

Screens Element

Each admin-interface element must contain exactly one screens element.

The screens element is a container for all the screens in an interface.

The screens element does not take any attributes.

Screen Elements

Each screens container may contain zero or more screen elements.

Each screen element defines a single screen type in an admin-interface, and is itself a container for Administration Interface components.

The screen element takes a single attribute, called type. The value of the type attribute is any alphanumeric string, the value of which must be unique within the screens container. The type attribute can take any one of the following values, which correspond to recognised screen types in the Administration Interface:

login

message

administration-menu

administration-users-select

administration-users-edit

administration-users-delete

administration-users-add-group

administration-users-add-users

administration-question-edit

administration-projects

administration-logs

Header Element

Each screen container may have zero or one header element.

The header element determines the content for information that can be displayed at the top of a page in the Administration Interface.

The header element does not have any attributes.

Title Element

Each screen container may contain zero or one title element.

The title element determines the content for information that can be presented as the title for a page in the Administration Interface.

The title element does not have any attributes.

Description Element

Each screen container may contain zero or one description element.

The description element determines the content for information that can be presented as descriptive, explanatory, or instructive text for a page in the Administration Interface.

The description element does not have any attributes. logo element

Each screen container may contain zero or one logo element.

The logo element contains a reference to an image to be inserted as a logo for the Administration Interface.

The logo element does not have any attributes.

Menu-Bar Element

Each screen container may contain zero or one menu-bar element.

The menu-bar element contains descriptions of a list of hyperlinks to allow the user to jump to specific resources or pages within (or outside of) the Administration Interface.

The menu-bar element does not have any attributes.

Controls Element

Each screen container may contain zero or one controls element.

The controls element is a container for specific controls that may appear on the screen to allow the Administrator to interact with the Administration Interface. Each screen type will utilise different sets of control elements.

The controls element does not have any attributes.

Buttons Element

Each screen container may contain zero or one buttons element.

The buttons element is a container for specific buttons that usually submit information from controls in the control area of a screen. The buttons may also cause an action to be cancelled rather than submitting information.

The buttons element does not have any attributes. footer element

Each screen container may have zero or one footer element.

The footer element determines the content for information that can be displayed at the bottom of a page in the Administration Interface.

User Interface XML

The User Interface XML contains all of the screen structure elements for the User Interface, which provides a web interface to present question content and record results within each Application. This is done by breaking down the entire interface into a number of discrete “screens” that each have individual layouts. There are a discrete number of screen elements that can appear, and each screen type will make use of different combinations of screen elements.

Interface Element

The root element for the User Interface XML file is the interface element.

The interface element defines an entire interface, and contains all other elements within the XML file.

The interface element takes a single attribute, called name. The name attribute has as its value any alphanumeric character string. The name attribute is set to the same value as the name of the Application to which it belongs, and therefore is unique among all XML files within a System.

Screens Element

Each interface element must contain exactly one screens element.

The screens element is a container for all the screens in an interface.

The screens element does not take any attributes.

Screen Elements

Each screens container may contain zero or more screen elements.

Each screen element defines a single screen type in an interface, and is itself a container for User Interface components.

The screen element takes a single attribute, called type. The value of the type attribute is any alphanumeric string, the value of which must be unique within the screens container. The type attribute can take any one of the following values, which correspond to recognised screen types in the User Interface:

login

topframe

secondframe

banner

message

application-welcome

application-new-project

application-modify-project-select

application-modify-project

application-delete-project

application-project-menu

application-document-menu

application-new-document

application-modify-document

application-delete-document

application-report

application-page

application-question-mcq

application-question-text

Header Element

Each screen container may have zero or one header element.

The header element determines the content for information that can be displayed at the top of a page in the User Interface.

The header element does not have any attributes.

Title Element

Each screen container may contain zero or one title element.

The title element determines the content for information that can be presented as the title for a page in the User Interface.

The title element does not have any attributes.

Description Element

Each screen container may contain zero or one description element.

The description element determines the content for information that can be presented as descriptive, explanatory, or instructive text for a page in the User Interface.

The description element does not have any attributes.

Logo Element

Each screen container may contain zero or one logo element.

The logo element contains a reference to an image to be inserted as a logo for the User Interface.

The logo element does not have any attributes.

Menu-Bar Element

Each screen container may contain zero or one menu-bar element.

The menu-bar element contains descriptions of a list of hyperlinks to allow the user to jump to specific resources or pages within (or outside of) the User Interface.

The menu-bar element does not have any attributes.

Navigation-Bar Element

Each screen container may contain zero or one navigation-bar element.

The navigation-bar element contains descriptions of a list of hyperlinks to allow the user to navigate to particular questions or sections within a set of questions.

The navigation-bar element does not have any attributes.

Controls Element

Each screen container may contain zero or one controls element.

The controls element is a container for specific controls that may appear on the screen to allow the User to interact with the User Interface. Each screen type will utilise different sets of control elements.

The controls element does not have any attributes.

Buttons Element

Each screen container may contain zero or one buttons element.

The buttons element is a container for specific buttons that usually submit information from controls in the control area of a screen. The buttons may also cause an action to be cancelled rather than submitting information.

The buttons element does not have any attributes.

Footer Element

Each screen container may have zero or one footer element.

The footer element determines the content for information that can be displayed at the bottom of a page in the User Interface.

The footer element does not have any attributes.

Question Content XML

The Question Content XML contains the information for all question contents in an Application, including structure of the decision tree and control logic that defines a User's progress through the decision tree.

Basically, Applications have one ore more Sections, each Section has one or more Pages, and each Page has one or more Questions. Question contents and structure are defined using the following XML elements:

Application Element

Each application element is the root element for the Question Content XML file.

The application element is a container for all other elements in the Question Content XML.

The application element takes a single attribute, called name. The name attribute has as its value any alphanumeric character string. The name attribute is set to the same value as the name of the Application to which the Question Content XML belongs, and therefore is unique among all XML files within a System.

Section Element

Each application element may contain one or more section elements.

Each section element defines a subset of questions within the question structure.

The section element takes a single attribute, called name. The name attribute identifies the section, takes as its value any alphanumeric string that conforms to the Standard Naming Requirements. The section name must be unique within each application container.

The section element is a container that can contain further section elements, allowing for multiple levels of the decision tree structure.

Page Element

Each section element can contain one or more page elements.

A page element can be used to group several questions on a single screen when presented via the User Interface, so that they are presented and answered simultaneously.

The page element takes a single attribute, called id. The id attribute identifies the page uniquely, and takes as its value a number. The page id must be unique within each application container.

The page element is a container for two sub-elements: control and question.

Control Element

Each page element may contain zero or one control element.

The contents of a control element define how the User progresses through the decision tree, by providing a series of conditions to be met along with outcomes of the conditions being met. In natural language, the logic may determine that “if the answer to question 4 is A, go to page 16”.

If no control element exists for a page container, the default control logic states “If there are further questions in this section, go to the next question, otherwise, go to the next question in the superordinate section in the decision tree.”

Question Element

Each page may contain one or more question elements.

A question element defines a single question within the decision tree.

The question element takes two attributes, called id and type. The id attribute is a number that uniquely identifies the question within an application. The type attribute determines what type of question is to be presented, and currently can take one of two values: “mcq” (for a multiple choice question) or “text” (for a text entry question).

Each question element is a container for the following elements: question-body and question-response.

Question-Body Element

Each question element must contain exactly one question-body element.

The question-body element defines the text and/or other content for the body of each question.

Question-Response Element

Each question can contain zero or more question-response elements.

A question-response element takes two attributes, called id and type. The id attribute is a number used to uniquely identify this response within an application container. The type attribute currently takes one of two values; “text” (for a text entry box) or “radio” (for a radio button).

Question-Response-Feedback Element

Each question-response element can contain zero or one question-response-feedback element.

The question-response-feedback element is a container for text that is related to each response.

The text will ordinarily be used in reports generated by the User Interface, such that if a particular response is selected or answered, then the corresponding question-feedback-response text appears in the report.

Database Structures

Application Information Table

The Application Information Table contains basic information about each Application in the System.

When a new Application is created in the System, information is automatically entered into this table before any other information about the Application can be stored in the System.

Because this table contains a field for the Application name, the name of an existing application should only ever be changed from within the Administration Interface. The name of the Application shouldn't be changed simply by renaming the Application subdirectory in the file system, because other associated information will then refer to an unknown Application name and a new entry will be added to this database when the renamed Application is next accessed. Renaming an Application via the Administration Interface allows the System to ensure that Application names are updated both in the file system and in the database.

The following fields comprise the Application Information Table:

application_id—this is a number uniquely identifying the Application (unique within the System).

name—a text field containing the name of the Application.

description—a text field (optionally) containing a description for the Application.

Project Information Tables

The Project Information Tables store information about Projects in the System's Database Management System and are accessed via the Interface Manager component.

While only one set of Project Information Tables exists for the System, project information is always linked to a single Application via User and/or Group references, so effectively entries in the Project Information Tables always have an Application scope.

There are two Project Information Tables: Project Information Table and Project Users Table.

The Project Information Table stores information about each project that is currently active in the Application. It also helps to ensure that only one user is able to modify a project at one time. It contains the following fields:

project_id—a number uniquely identifying this Project within the System. This is the primary key for this table.

user_id—a number identifying the user who is the owner of this project. This is a foreign key into the user_id field of the User Information Table. From this field it is possible to determine the Application that is the scope for the Project.

name—a text field containing the name of the Project.

description—a text field containing an optional description for this Project.

creation_time—a number representing the time at which this Project was created. The number indicates time as the number of seconds that had elapsed since Jan. 1, 1970. This value is used to link a Project to its initial version.

modification_time—a number representing the time at which this Project was last modified. The number indicates time as the number of seconds that had elapsed since Jan. 1, 1970. This value is used to link a Project to its current version in the Project Results Tables.

modification_user—a number indicating who was the last User to modify this Project. If the Project is currently being modified, then this is the User currently making modifications. This is a foreign key into the user_id field of the User Information Table.

modification_lock—a Boolean field indicating whether the Project is currently being modified. This is used to ensure that only one User is able to modify a Project at any one time. When a User logs in to modify a Project, the modification_lock must be set to false before they are able to modify the Project. If it is set to false, then the User is said to gain the lock; modification_lock is set to true and modification_user is set to the User's user_id. If the modification_lock is true, the User will only be able to view the Project, but not modify it. If a User gains the lock but remains inactive for 30 minutes or more, another User will be able to gain the modification_lock, to allow the System to recover from disconnected or improperly terminated sessions.

When a Project is created, the owner may give permission for other Users or Groups to read and/or modify the Project. This allows multiple Users to work collaboratively on a Project. Information about which Users and Groups have permission to read and/or modify a Project is stored in the Project Users Table, which contains the following fields:

project_id—a number identifying which Project has access rights granted. This is a foreign key into the project_id field of the Project Information Table.

group_id—a number indicating a Group that is given access to read and/or modify the specified Project. This is a foreign key into the group_id field of the Group Information Table. If this field is not NULL, then the user_id field of this table must be NULL, but equally if the user_id field of this table is NULL, this field must not be NULL.

user_id—a number indicating a User that is given access to read and/or modify the specified Project. This is a foreign key into the user_id field of the User Information Table. If this field is not NULL, then the group_id field of this table must be NULL, but equally if the group_id field of this table is NULL, this field must not be NULL.

permissions—a number indicating the type of access that is granted to the User or Group for the specified Project. Current valid values are: 0=no access, 1=read access, 2=modify access, 3=read and modify access.

Document Information Table

The Document Information Table stores information about Documents in the System's Database Management System, and are accessed via the Interface Manager component.

While only one Document Information Table exists for the entire System, document information is always linked to a single Project and a single Application via User and/or Group references, so effectively entries in the Documents Information Tables always have a Project scope.

The Document Information Table has the following fields:

document_id—a number uniquely identifying this document in the System. This number also serves as the filename for the document when it is saved in the Application Host's file system under the User Resources Area.

user id—a number identifying the User who is the owner of this document. This is the User who uploaded the document into the User Resources Area. This field is a foreign key into the user id field of the User Information Table.

project_id—a number identifying which Project the document belongs to. All documents must be stored in the context of a Project. This field is a foreign key into the project_id field of the Project Information Table.

name—this text field is the original file name for the document, including the document's original file extension.

description—this is a text field that is used to optionally supply a description for the document.

modification_time—a number representing the time at which this document was uploaded (actually, this value really represents the modification time of the Project version that is linked to this document). The number indicates time as the number of seconds that had elapsed since Jan. 1, 1970. This value is used to link the document to a particular version of a Project.

User Profiles Tables

The User Profiles Tables are stored in the System's Database Management System and accessed by components via the User Profiles Manager Component.

In addition to User Profiles, the database also stores related information about Applications and Projects in the System.

While only one set of User Profiles Tables exists for the System, user information is always linked to a single Application, so information effectively always has an Application scope. Scoping is handled by the User Profiles Manager component.

The User Profiles Tables consist of the following tables: User Information, Group Information, Group Memberships, and Group Supervisors.

The User Information Table contains information about each user in the System. It contains the following fields:

user_id—a number uniquely identifying the user (unique within the System). This is a primary key for the table.

name—a text field containing the user's full name.

email—a text field containing the user's email address.

login—a text field containing the user's login name. The login must contain between 1 and 32 alphanumeric characters and be unique within each Application.

password—a text field containing the user's password (may be stored as plain text or encrypted). The password must contain between 4 and 32 alphanumeric characters.

application_id—a number identifying the name of the application that the user belongs to. This is a foreign key into the application_id field of the Application Information Table.

The Group Information Table contains information about each of the groups defined in the System. It is comprised of the following fields:

group id—a number uniquely identifying the group (unique within the System). This is a primary key for the table.

name a text field containing the name of the group. The name must contain between 1 and 32 alphanumeric characters and be unique within the System.

description—a text field containing a description of the group.

application_id—a number identifying the Application that the user belongs to. This is a foreign key into the application_id field of the Application Information Table.

The Memberships Table provides information about which users are members of which groups:

group_id—a number identifying which group a user belongs to. This is a foreign key into the group_id field of the Group Information Table.

user_id—a number identifying the user who belongs to the group specified in group_id. This is a foreign key into the user_id field of the User Information Table.

status—a number indicating what the status of the User is in the specified Group. Currently defined values are: 0=inactive; 1=member; 2=supervisor.

User Results Tables

The User Results Tables are stored in the System's Database Management System and accessed by components via the User Results Manager component.

While only one set of User Results Tables exists for the System, results information is always linked to a single Application via User Information, so information effectively always has an Application scope.

The User Results Tables consist of two tables: Results Data Table and Results Index Table.

The Results Data Table contains the answers provided by all users to all questions in the System. This includes all versions of all answers where several versions of an answer have been stored. Data in this table may be referenced by any User, in any Project, in any Application in the System, and data is never duplicated in the table. Where the same answer has been provided to different questions (and/or by different Users, and/or in different Projects and/or in different Applications), only one copy of the data for the answer will be stored in this table, but there may be multiple references to the data for each version of each Project in each Application. This provides a very space-efficient way of storing data across the entire System. The Results Data Table consists of the following fields:

result_id—this is a number uniquely identifying this piece of data (unique within the System). This is a Primary Key for the table.

result_data—a text field used to store the actual content of an answer.

The Results Index Table contains references to the answers provided by all users to all questions in the System. Every version of every Project in each Application will have an index of references in this table that specify what the answer for each question in the Project was. The Results Index Table consists of the following fields:

result_id—this is a number providing a reference to a piece of data stored in the Results Data Table. This is a Foreign Key into the result_id field of the Results Data Table.

user_id—a number indicating the user who provided this answer. This is a foreign key in to the user_id field of the User Information Table.

project_id—a number specifying which Project this answer belongs to. This is a Foreign Key into the project_id field of the Project Users Table.

question_id—a number indicating which question was answered. This number must correspond to an id number for a question in the Question Content XML for the Application. is modified a Boolean value indicating whether this version of the answer is new content. This is set to 0 if the answer has not changed since the previous version of the Project, or 1 if the answer has changed since the previous version of the Project.

modification_date—a number indicating the time that the question was answered. Actually, more accurately, this number represents the modification time for the version of the Project that this answer belongs to. The time is represented as the number of seconds elapsed since Jan. 1, 1970. This value is used to link this answer for the question to a particular version of a project.

Schedule Tables

The Schedule Tables are stored in the System's Database Management System and accessed by components via the Interface Manager component.

While only one set of Schedule Tables exist for the System, schedule information is always linked to a single Application via a user who is the owner of the event, so information effectively always has an Application scope.

The Schedule Tables consist of a two tables: Event Information Table and Recipients Table.

The Event Information Table contains details about each scheduled event in the System. It is checked regularly by the Interface Manager to determine whether any scheduled events need to be actioned. If so, the appropriate action is taken and the event is removed from the Event Information Table. The table contains the following fields.

event_id—a number uniquely identifying this event (unique within the System).

event_type—a number indicating the type of event. Currently there are only two defined values for event type: 1=SEND_EMAIL; 2=APPEND_LOG.

user_id—a number indicating the user who owns or initiated this event. In the case of a SEND_EMAIL event, for example, this is the sender. This is a foreign key into the user_id field of the User Information Table.

timestamp—a number indicating the time that the event should be triggered. The time is represented as the number of seconds elapsed since Jan. 1, 1970. A value of zero means ‘now’.

name—text representing the name of the event. In the case of a SEND EMAIL event, this becomes the subject line.

description—a text field representing the content of the event. In the case of a SEND_EMAIL event, this represents the body of the message.

The Recipients Table stores information about which users are recipients or targets of each event. In the case of the SEND_EMAIL event, these users are the recipients of the message. Recipients are stored in a separate table in order to allow for multiple recipients of each event. The table contains the following fields.

event_id—a number indicating which event is involved. This is a foreign key into the event_id field of the Event Information Table.

user_id—a number indicating the user who is the recipient of the event. This is a foreign key into the user_id field of the User Information Table.

User Interface Functionality

Details of the operation of the User Interface Functionality will now be described. Although some suggestions for the layout and appearance of the User Interface are made for illustrative purposes, it will be appreciated by the skilled reader that many variations are possible. The reason for this is that the specifications and design of the User Interface aims to cover an infinite variety of possible presentations.

Overview of the User Interface

The User Interface is designed to do three basic things: restrict access to question contents to authenticated Users, provide views on particular areas of question contents to Users (managing progress through the Decision Tree), and store Users' responses to questions in a database for later retrieval.

The User begins by logging in to the User Interface via a login screen that requires them to input their login name and a secret password.

After logging in, the User proceeds to a welcome screen listing the current Projects that are available.

The User selects a Project to work with, or chooses to begin a new Project.

Within the context of a Project, the User can access a map of a Decision Tree.

The Decision Tree map gives access to Pages of questions in an application.

Pages are presented in a sequential order, with the next Page presented determined by control logic embedded in the page definition.

After a User has completed a Project, they may access a report that presents a custom view of the responses to questions that the User has provided.

Progression Through the Decision Tree

When the User begins working through the questions in a Project, questions are presented according to the following rules. Access to the Decision Tree is initially gained by selecting a Section in the Decision Tree (Sections are listed on the Project Map). When the User accesses a Section, they will be presented with the first item in that Section. This is the current Section.

If the first item in a Section is another Section, then the User will be presented with the first item in that sub-section (and so on down the Decision Tree until a Section contains a Page as its first item). This then becomes the current Section.

If the first item in the current Section is a Page, the User will be presented with the Questions that are associated with that Page. This is the current Page.

When the User moves on from the current Page, and there is no control logic specifying the next point in the Decision Tree, one of four things may occur:

If there exists another item in the current Section, and that item is a Page, then the user is presented with the Questions associated with that Page, which becomes the current Page.

If there exists another item in the current Section, and that item is a Section, the User is presented with the first item in that sub-section (and so on down the Decision Tree until a Section contains a Page as its first item). This then becomes the current Section.

If there exist no more items in the current Section, and the current Section is not a top-level Section (i.e. it is a subsection of another Section), then the User is presented with the item that follows the current Section in the current Section's superordinate Section.

If there exist no more items in the current Section, and the current Section is a top-level Section (i.e. it is not a subsection of any other sections), then the User is presented with the Project Map.

The conditional tests in repeated until the User exits a Project or ends their session.

User Interface Screen Structure

The User Interface Screen structure will now be described with reference to FIG. 3.

Because this structure is embodied in the User Interface XML and User Interface XSL documents, each Application is free to implement a different or customised structure since each Application has its own copy of User Interface documents.

The User Interface screen 70 is made up of two top-level frames, dividing the page horizontally.

The upper top-level frame 71 is referred to as the “static” frame. It is used to contain information that is loaded at the beginning of a user's session and which does not change as the user progresses through the User Interface (such as a company logo, or “help” and “contact” hyperlinks).

The lower top-level frame 72 is referred to as the “dynamic” frame. Its contents change regularly and are determined by the User's current position in the Application and other state settings.

There is no visible border between the static and dynamic frames, and the frames are not resizable. The static frame has a fixed height, the dynamic frame height adjusts to occupy the remainder of the screen.

Inside the dynamic frame 72, one of two frame set structures can be in place, depending on a state setting that can be changed by the User during a session.

In the first state (“closed state”), the dynamic frame contains a single subordinate frame called the “application” frame 74. The application frame 74 is used to present dynamic interface information to the User, for example, displaying a question as an HTML form.

In the second state (“open state”), the dynamic frame 72 holds a secondary frame set composed of two frames that divide the dynamic frame vertically.

The purpose of splitting the dynamic frame into a further frame set is to allow the user to open other documents for viewing alongside the application frame. The left-most frame in the second-level frame set is referred to as the “document” frame 73, and when open, contains a document opened from the Application's User Resource Area. For example, it would be possible to view reference material in the document frame 73 while answering questions about the reference material in the application frame 74.

It is only possible to open one document at a time in the document frame 73. However it is also possible to open documents for viewing in separate browser windows, and this would allow multiple open documents in addition to the application frame.

The right-most frame in the secondary frame set is referred to as the “application” frame. It contains content from the Application, such as questions to be answered by the user.

In the open state, there is a visible border between the application frame and the document frame, which allows the user to dynamically resize the frames at will.

The Interface is generated via XML-XSL transformations, whereby textual content for the interface is stored in the User Interface XML file, and instructions on which parts of the interface are presented, and how, are included in the User Interface XSL document.

The entire interface is comprised of seven basic kinds of User Interface screens (but note that the XML implementation is designed to allow for new types to be added as required). The purpose of having different screen types is to allow for a variety of formats within a single interface. For example, a login screen has a different format to an error message, which is again different to a question.

When the User Interface is accessed it will be passed information on the user's position and status in the Application via embedded HTML form variables. The User Interface XSL document uses the embedded information to determine which screen type to display at what times.

The User Interface XML file contains only information about the layout and appearance of each screen type. It is effectively a template for each screen type. The actual content for each screen is drawn from either the XSL document (in the case of reporting an error, for example), other components (in the case of generating a results report, for example) or the Question Content XML file (in the case of presenting a question).

Accessing the User Interface

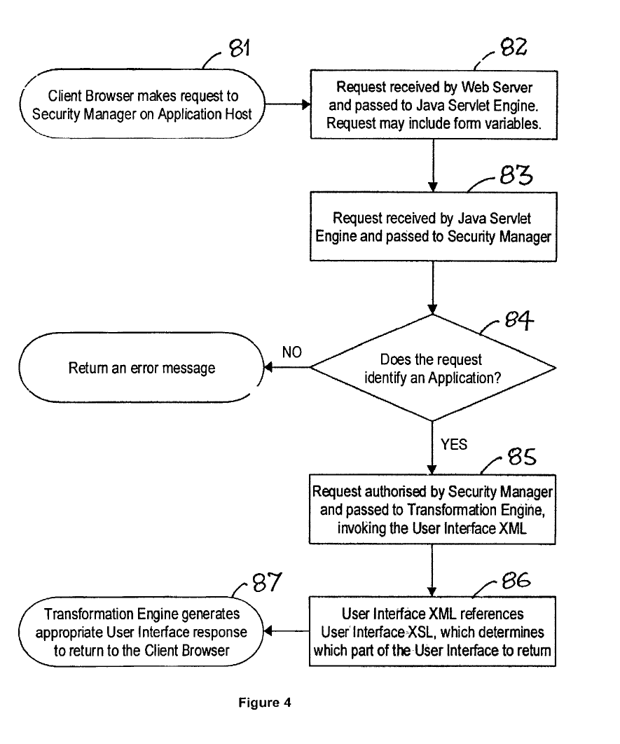

FIG. 4 shows the flow of control among System components when accessing the User Interface. Users access the interface at step 81 with a URL that references the User Interface indirectly via the Security Manager servlet on the System.

Different areas of the interface are accessed by posting HTML Form variables 82 to the Security Manager 83. For example, form variables are used to indicate which Application is identified 84, the user's current location in the Application, which answers are given to questions, etc.

After authorising a request, the Security Manager passes appropriate form variables on to the Transformation Engine 85. These are then available for the Transformation Engine to use 86 when generating the response 87 from User Interface XML and User Interface XSL documents.

At a minimum, each request to the User Interface via the Security Manager must specify an Application. When accessing the User Interface for the first time in a session, this will normally be done by simply appending a question mark character and then the Application Name to the end of the URL referencing the Security Manager. For example, if the URL to refer to the Security Manager were

“http://lawofthejungle.com.au/servlet/com.lotj.marketeer.Secure”,

then to access the Application called “Sample-Questions”, the full URL would be:

“http://lawofthejungle.com.au/servlet/com.lotj.marketeer.Secure?Sample-Questions”.

Authentication for the User Interface

When the User Interface is accessed for the first time in a session, the user will be prompted to log in by submitting their login name and a password via an HTML form.

After submitting their details, they are checked against the User Profiles database tables.

If the login details are valid, the Security Manager generates a random string of characters for the user as a Session Key. This Session Key is subsequently embedded as an HTML form variable in all future requests made by the same user in the same session.

The Security Manager maintains an internal record of all currently valid Session Keys, along with the details of the users to whom the key belongs.

Session Keys become invalid after a period of 30 minutes of inactivity (i.e. no requests to the User Interface being made). This effectively logs the user out of the system after 30 minutes of inactivity as an added security precaution and to efficiently manage internal memory resources.

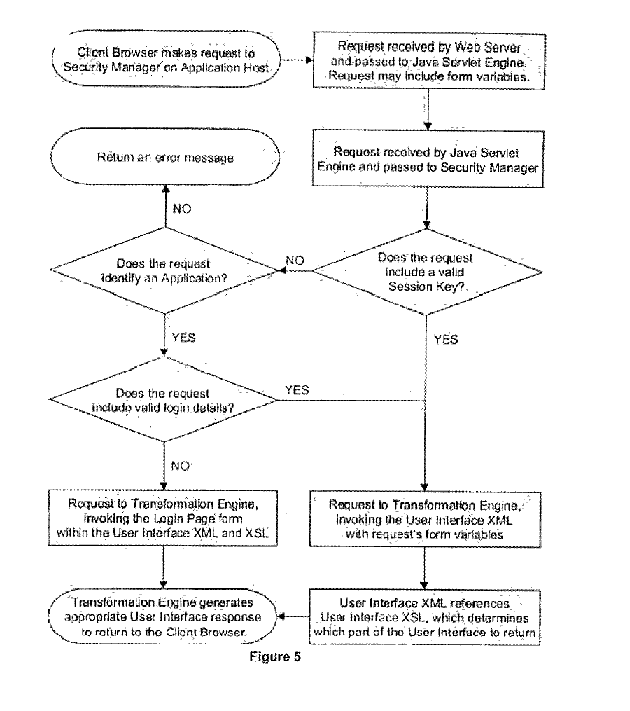

FIG. 5 builds on the process outlined in FIG. 4 to show the process of authentication and logging in to the User Interface.

Login Screen

If the user accesses the User Interface and the accessing request does not include either a valid Session Key or login details, the user will be presented with a login screen.

Note that the login screen appears before the frame sets creating static and dynamic frames are created, and thus the login screen always occupies the entire browser window.

The login screen has the following components.

header—header text to identify the Application

title—a title for the page

description—a message to welcome the user and explain how they can log in to the User Interface.

control area—an area of the screen in which the User is able to control the User Interface.

user login field—in the control area, this is a text box into which the user may enter their user id. This is an HTML form input text element.

user password field—inside the control area, this is a text box into which the user may enter their password. This is an HTML form input password element.

submit button—a button to submit the login details. This is an HTML form input submit element.

footer—footer text to provide a disclaimer, copyright etc.

Document Screen

If the User Interface enters open state, the document screen appears on the left of the application screen.

The User Interface can be changed from open to closed state at will by the User clicking on a hyperlink embedded in the application frame.

The document screen is only ever occupied by the contents of a document that has been opened from the User Resource Area, and therefore doesn't actually require a screen type to be defined in the User Interface XML file (it is the only screen type that does not need such a definition).

Documents are opened and closed via a hyperlink that appears in the application screen.

Application Screen

The application screen requires a number of individual templates, each of which allows the application screen to perform a separate function in the User Interface. The individual templates are identified by appending a state descriptor to the application template name, for example; application-project-menu.

Exemplary application screens defined for the interface are: application-welcome, application-new-project, application-modify-project-select, application-modify-project, application-delete-project, application-project-menu, application-document-menu, application-new-document, application-modify-document, application-delete-document, application-report, application-page, application-question-mcq, and application-question-text. These are described in detail below.

Application-Welcome Screen

The application-welcome screen is the first application screen presented to the user after logging in.

The screen lists all of the projects that are currently available to the User, and allows them to enter or manage those projects.

The dynamic contents of the application-welcome screen are generated with the assistance of the Interface Manager.

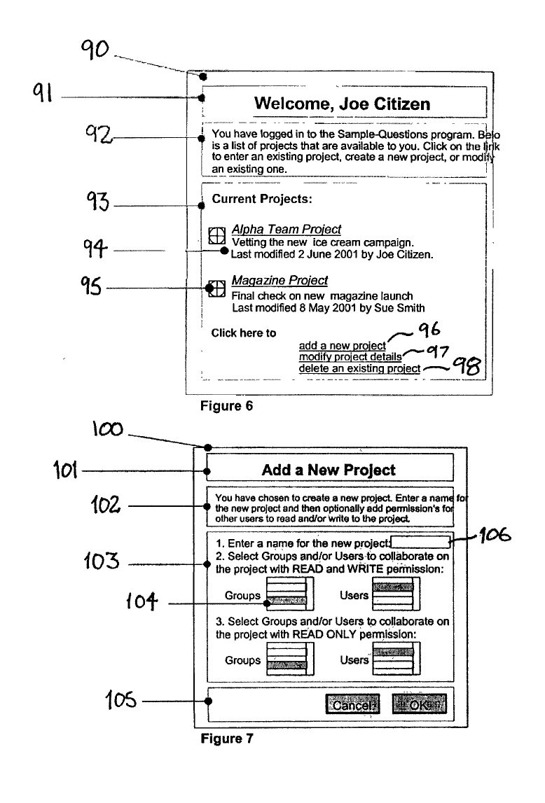

A sample layout screen 90 is illustrated in FIG. 6 and has the following components:

title 91—a title for the screen.

description 92—introductory/explanatory text for the screen.

control area 93—an area of the screen in which the User is able to control the User Interface.

project list 94—the main purpose of the control area is to provide a list of currently available Projects that the user can begin working on. The project list includes Projects where:

the User is the owner of the Project;

the User has been assigned to the Project;

any Group that the User belongs to has been assigned to the Project;

the User is a Supervisor in a Group that the owner of a Project belongs to.

Each Project is listed by its name, description, last modification time and the User who made the last modifications. The Project names in the list are hyperlinks that take the User to the application-project-menu screen for the relevant Project. If there are no Projects available to the User, the message “No Projects are currently available.” will appear in place of the Project list.

status icons 95—beside each Project name in the project list, a status icon is displayed. This icon is one of four small images, which give a visual indication of whether the User's access rights for each Project are “owner/supervisor” (meaning the User has full control over the Project), “read and write” (meaning the User is able to answer questions in the Project, add new documents, but not modify properties of the Project), “read only” (meaning the User can view the Project but not answer any questions or make any changes), or “locked” (meaning that another User is currently modifying the Project so it is currently available with read only permissions, even if the User would ordinarily have higher-order permissions).

other links—underneath the project list a number of hyperlinks may appear. These include:

add a new project 96—if the User clicks this link they will be taken to the application-new-project screen.

modify project details 97—if the User clicks this link they will be taken to the application-modify-project-select screen.

delete an existing project 98—if the User clicks this link they will be taken to the application-delete-project screen.

Application-New-Project Screen

If the User clicks the ‘add a new project’ hyperlink on the application-welcome screen, they will be taken to the application-new-project screen.

The purpose of this screen is to provide an interface allowing the User to create a new Project.

The dynamically generated portions of the application-new-project screen are generated with the assistance of the Interface Manager and the User Profiles Manager.

A sample application-new-project screen 100 is shown in FIG. 7 and includes the following components:

title 101—a title for the screen.

description 102—introductory/explanatory text for the screen.

control area 103—an area of the screen in which the User is able to control the User Interface.

new project name field 106—the control area contains a text box into which the user can enter a new name for the Project. This name must conform to the Standard Naming Requirements. When the User attempts to submit this form, JavaScript will be used to verify that the name does in fact conform to the requirements. If the name does not conform, an alert box will appear asking the User to change the new project name.

multi-select menus 104—under the new project name field, two pairs of multi-select input controls are displayed. Multi-select inputs are menus of items that allow several items in each menu to be selected. The first pair of input controls are used to specify those other Users and Groups who are to be assigned to this Project with “read and write” permissions. This means that those Users and Groups will be able to collaborate on the Project by viewing and answering questions, and adding documents to the project. The second pair of input controls are used to specify those other Users and Groups who are to be assigned to this Project with “read only” permissions. This means that those Users and Groups may view the Project, but may not answer questions or add documents. Within each pair, one input control contains a list of all Groups that the User belongs to, the other lists all Users who are members of Groups that the User belongs to. It is not necessary to assign any other Groups or Users, if collaboration is not required or desired.

submit buttons 105—these are buttons that are pressed to submit the new project details. The “Cancel” button is used to return to the application-welcome screen without creating a new Project. The “OK” button is used to return to the application-welcome screen after creating a new Project. A User may modify or delete Projects, provided they possess the appropriate user permissions, using similar screens to that shown in FIG. 7 that allow the user to select and manipulate the relevant Project.

Application-Project-Menu Screen

If the User clicks on the name of a Project on the application-welcome screen, they will be taken to the application-project-menu screen for that Project.

The purpose of the application-project-menu screen is to provide a main menu for accessing various questions and other resources in the Project.

The dynamic contents of the application-project-menu screen are generated with the assistance of the Interface Manager.

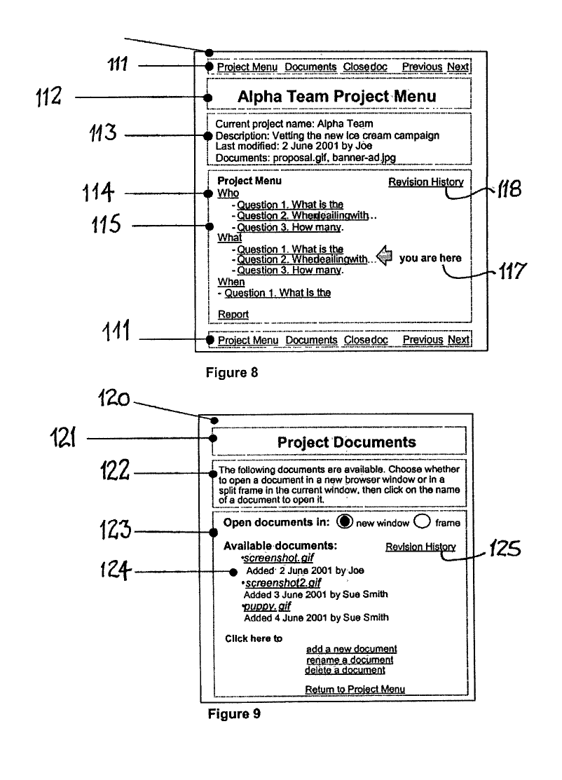

A sample layout of the application-project-menu screen 110 is shown in FIG. 8 and consists of the following components:

navigation bar 111—a navigation bar for navigating around a project. This bar contains a number of links, including:

project menu—allowing the user to jump back to the application-project-menu screen.

documents—allowing the User to access documents that have been added to this Project. This takes the User to the application-document-menu screen.

close doc—this only appears if the User Interface is in open state. It allows the User to close the document that is currently open in the document frame and to return the User Interface to closed state.

previous—take the User to the previous question in the Project.

next—take the User to the next question in the Project.

title 112—a title for the screen.

description 113—introductory/explanatory text for the screen.

control area 114—an area of the screen in which the User is able to control the User Interface.

project map 115—the main purpose of the control area is to provide a list of currently available questions within the Projects. These questions are displayed in the appropriate decision tree structure to assist their navigation (that is, questions are displayed in a visual hierarchy displaying the section-page-question structural relationships). The project map includes only those questions that are currently available to the User. Available questions are questions that the User has previously answered, and that are accessible via the control logic of the decision tree structure. As the User progresses through the decision tree structure by answering more questions, more of the Project map will become visible. Each question appears as a hyperlink, and if the User clicks on this link they will be taken to an application-page screen that contains the question. A User is permitted to change answers to questions that have previously been answered, however it should be noted that changing answers may impact on the structure of the Project map itself, depending on the control logic of questions in the decision tree. A parameter can be set in the User Interface XML file to show but not hyperlink top-level sections in the Project map, so that even if the User has not completed questions in those sections the structure of the top-level sections will be visible. A further parameter in the User Interface XML file can be set to show and hyperlink top-level sections in the Project map, so that even if the User had not completed questions in all sections, they would be able to enter the top-level section to complete questions out of sequence. If there are no questions available to the User, the message “No questions are currently available.” will appear in place of the Project map.

status icons—beside each section and question in the Project map, a small status icon appears to indicate the question's status. The icon is one of two graphics indicating whether the question has been answered (for example, a closed circle) or not answered (for example, an open circle).

you are here marker 117—this is a small icon that appears in the Project map to indicate the last question that was answered by the User. The purpose of this icon is to make it easy for the User to resume work on a project over multiple sessions.

revision history link 118—this is a hyperlink that only appears if the current User is the owner of a Project, or a Supervisor of the owner of a Project. Clicking on this link takes the user to the application-revisions-menu screen, where the user can view a summary of revisions to the Project by User and modification date.

Application-Document-Menu Screen

The application-document-menu screen appears if the User selects the Documents link from a navigation bar menu in the Interface.

The screen lists all of the documents that are currently available to the User, and allows them to open or manage those documents.

The dynamic contents of the application-document-menu screen are generated with the assistance of the Interface Manager.

A sample layout of the application-document-menu screen 120 is shown in FIG. 9 and consists of the following components:

title 121—a title for the screen.

description 122—introductory/explanatory text for the screen.

control area 123—an area of the screen in which the User is able to control the User Interface.

document list 124—the main purpose of the control area is to provide a list of currently available documents that the user can open. The document list includes any document that has been added to a Project by any User. At the top of the document list a radio button selection allows the User to choose whether to open documents in a new window, or in the document frame. If new window is selected, new documents will be opened into a new browser window. This allows for multiple documents to be opened at one time, but the User is required to switch back and forth among document windows. If the document frame is selected, then the User Interface will enter open state and the document will be opened within the document frame, to the left of the application frame. Only one document can be opened this way at one time, but the document can be viewed simultaneous with the application screen. In the document list, each document is listed by its name, version (if applicable), the User who added the document, and the date that the document was added. The document names in the list are hyperlinks that will open the document. If there are no documents available to the User, the message “No documents are currently available.” will appear in place of the document list.

revision history link 125—this is a hyperlink that only appears if the current User is the owner of a Project, or a Supervisor of the owner of a Project. Clicking on this link takes the user to the application-revisions-compare screen, where the user can view a summary of revisions to documents in the Project by User and modification date.

other links 126—underneath the project list a number of hyperlinks may appear. These include:

add a new document—if the User clicks this link they will be taken to the application-new-document screen.

rename a document—if the User clicks this link they will be taken to the application-modify-document-select screen.

delete a document—if the User clicks this link they will be taken to the application-delete-document screen.

Return to Project Menu—if the User clicks this link they will return to the application-welcome screen without opening new documents.

Application-New-Document Screen

If the User clicks the ‘add a new document’ hyperlink on the application-document-menu screen, they will be taken to the application-new-document screen.

The purpose of this screen is to provide an interface allowing the User to add a new document to a Project.

The dynamically generated portions of the application-new-document screen are generated with the assistance of the Interface Manager.

A sample layout for the application-new-document screen 130 is shown in FIG. 10 and has the following components:

title 131—a title for the screen.

description 132—introductory/explanatory text for the screen.

control area 133—an area of the screen in which the User is able to control the User Interface.

new document browse button 134—the control area contains a browse button by which the User can select a document on their local file system to add to the Project. This document will be added to the Document Information Table and copied to the User Resource Area, from where it will be available to other Users who access the same Project. Before the document is added to the Document Information Table it is checked to ensure that its name follows the Standard Naming Requirements. If not, then an automatic algorithm is run on the name to ensure that it conforms to the requirements.

description text box 136—in order to assist Project Users to keep track of documents, an optional description can be attached to each document. The user simply enters description information into this text box.

submit buttons 135—these are buttons that are pressed to submit the new project details. The “Cancel” button is used to return to the application-project-menu screen without adding a new document. The “OK” button is used to return to the application-project-menu screen after adding the new document.

A user can modify and or delete links to documents in a known manner using a screen similar to that shown in FIGS. 9 and 10.

Application-Page Screen

If the User clicks on a hyperlink to a question within the Project map on the application-project-menu screen, they will be taken to an application-page screen for the selected question.

One or more questions can be assigned to a single page, allowing for multiple questions to be presented together if desired.

The application-page screen portions that are dynamically generated are created with the assistance of the Interface Manager.

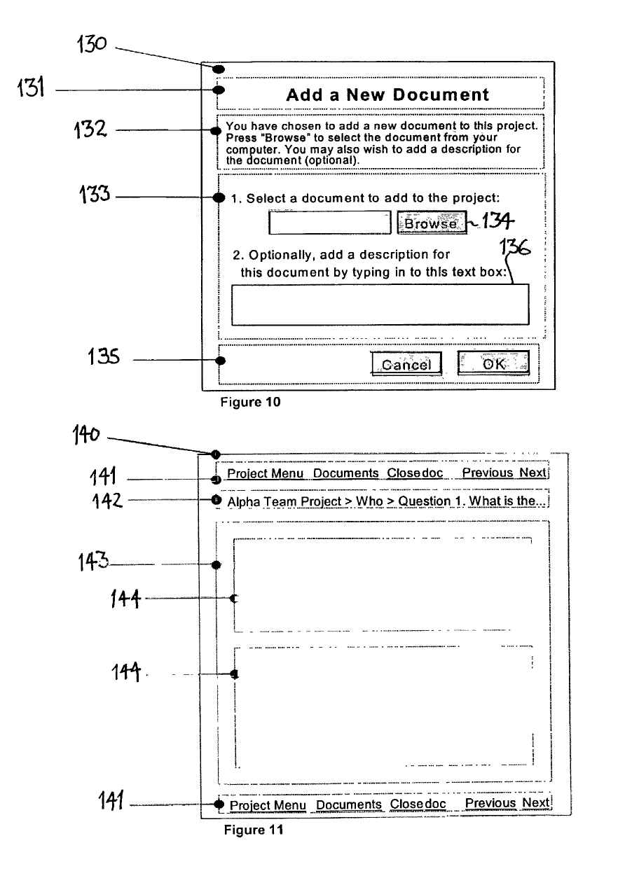

A sample layout of the application-page screen 140 is shown in FIG. 11 and is comprised of the following components

navigation bar 141—a menu bar for navigating around a project. This bar contains a number of links, including: project, documents, close doe, previous, and next, each of which have the analogous functions as described previously.

location bar 142—this item is a dynamically-generated list of the sections of the decision tree in which the User is currently located. It concisely conveys to the User their location in the Project Map.

page screen 143—an area set aside to contain the one or more questions that are linked to the current page.

question screen(s) 144—for each question that is linked to the current page, a question screen will be placed inside the page screen. The content for these screens will vary depending on the question type, and the question content as defined in the Question Content XML file.

Application-Question-mcq Screen

The application-question-mcq screen is used to format the question screen that appears when a question is of the mcq (Multiple Choice Question) type.

All portions of the application-question-mcq screen are dynamically generated with the assistance of the Interface Manager.

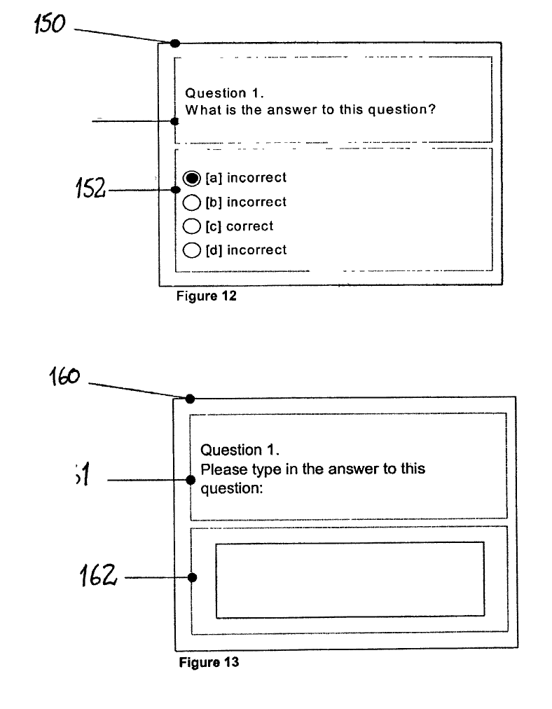

A sample layout of the application-question-mcq screen 150 is shown in FIG. 12 and contains the following components

question body 151—this contains text and XHTML tags to format the body of the question.

question choices 152—this contains a set of radio buttons and choice descriptions that allow the User to answer the question. There can be between zero and 20 individual choices per question. The upper limit of 20 is the preferred number but any upper limit can be established.

Application-Question-Text Screen

The application-question-text screen is used to format the question screen that appears when a question is of the text (Text Entry) type.

All portions of the application-question-text screen are dynamically generated with the assistance of the Interface Manager.

A sample layout of the application-question-text screen 160 is shown in FIG. 13 and contains the following components:

question body 161—this contains text and XHTML tags to format the body of the question.

question text box 162—this contains a single HTML text area input control into which the User can type a response to answer the question. The number or rows and columns in the text area can be adjusted in the Question Content XML definition for each text question.

Application-Revisions-Menu Screen

If the User clicks on the “Revision History” link on the application-project-menu screen they will be taken to the application-revisions-menu screen.

The purpose of the application-revisions-menu screen is to present a list of all revisions to items in a Project and allow the User to select one or more of those revisions to view, compare and/or restore into the Project.

The dynamic contents of the application-revisions-menu screen are generated with the assistance of the Interface Manager.

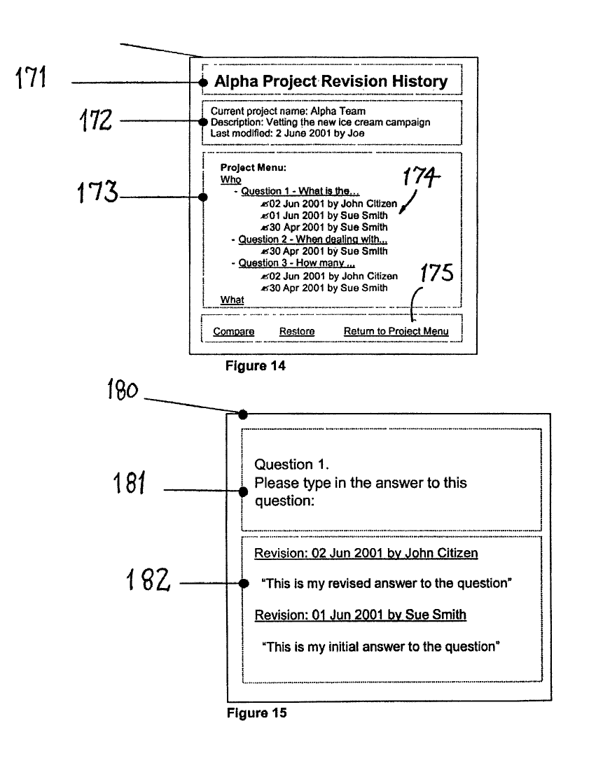

A sample of the application-revisions-menu screen 170 is shown in FIG. 14 and consists of the following components:

title 171—a title for the screen.

description 172—introductory/explanatory text for the screen.

control area 173—an area of the screen in which the User is able to control the User Interface.

revisions map 174—the main purpose of the control area is to provide a list of current and previous versions of the selected Project. Each question in the project is listed in the form of an indented list (in a similar format to that used in the project map on the application-project-menu screen). Under each question that has previously been answered in the Project, a list of revisions to answer for that question is displayed. Each item on the list of revisions has a checkbox beside it in order to allow the User to select one or more of the revisions. If the user wishes to Compare revisions or Restore revisions, it is the items selected on this list that become the subject of the operation.

other links 175—the following links are also displayed on the application-revisions-menu screen:

compare—if the User clicks on this link, then they are taken to the application-revisions-compare page, where they can view and compare the answers of previous revisions for all of the selected revision list items.

restore—if the User clicks on this link, they will be able to load selected previous revision contents back into the current revision. A confirmation JavaScript dialog will appear to ensure that the User wishes to select this action prior to the operation being performed. It is possible for a User to have more than one revision selected for restoration. If the User has selected more than one revision for the same question, then the most recent selected revision will be restored into the current revision.

Return to Project Menu—when the User is ready to exit the application-revisions-menu screen and return to the applications-project-menu screen they can click on this link.

Application-Revisions-Compare Screen

If the User selects one or more revision list items on the application-revisions-menu screen and clicks on the “Compare” link, they will be taken to the application-revisions-compare screen. It is important to note that this screen will appear in a new browser window.

The application-revisions-compare screen is used to view and/or compare one or more answers to questions as they were entered in previous revisions of the Project.

The application-revisions-compare screen has an open structure and its composition depends greatly on the number of revision list items selected and the type of revision list items selected. Generally, the structure of the page is: for each question that had one or more revision list item(s) selected, the body of that question is presented. Then, for each revision list item belonging to that question which is selected, the answer(s) corresponding to the selected revision(s) are displayed under the question body. If multiple revisions of answers for the same question are selected, the User can easily compare the selected revisions as they appear immediately after one another under the question body.

A sample layout of the application-revisions-compare screen 180 is shown in FIG. 15 and contains the following components:

question body 181—the screen will contain one or more of these elements (one for each question that has one or more answer revisions selected). This element contains text and XHTML tags to format the body of the question.

question answers 182—for each revision of an answer that is selected for the question, this area of the screen contains a listing of the answer given.

Application-Revisions-Documents Screen

If the User clicks on the “Revision History” link on the application-document-menu screen they will be taken to the application-revisions-documents screen.

The purpose of the application-revisions-documents screen is to present a list of all revisions to documents in a Project and allow the User to select one or more of those revisions to view and/or restore into the Project.

The dynamic contents of the application-revisions-documents screen are generated with the assistance of the Interface Manager.

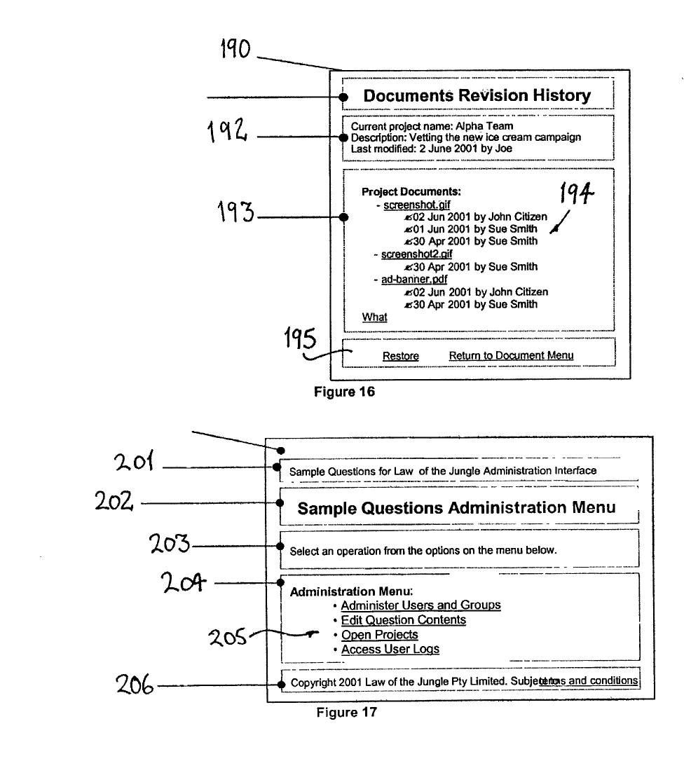

A sample layout of the application-revisions-documents screen 190 is shown in FIG. 16 and consists of the following:

title 191—a title for the screen.

description 192—introductory/explanatory text for the screen.

control area 193—an area of the screen in which the User is able to control the User Interface.

document map 194—the main purpose of the control area is to provide a list of current and previous versions of documents in the selected Project. Each document in the project is listed in the form of an indented list (in a similar format to that used in the project map on the application-document-menu screen). Under each document in the Project, a list of revisions for that document is displayed. Each item on the list of revisions has a checkbox beside it in order to allow the User to select one or more of the document revisions. If the user wishes to Restore previous version of documents, the checkbox is used to select the desired revision to restore.

other links 195—the following links are also displayed on the application-revisions-documents screen:

restore—if the User clicks on this link, they will be able to load selected previous revisions of documents back into the current Project. A confirmation JavaScript dialog will appear to ensure that the User wishes to select this action prior to the operation being performed. It is possible for a User to have more than one revision selected for restoration. If the User has selected more than one revision for the same question, then the most recent selected revision will be restored into the current revision.

Return to Documents Menu—when the User is ready to exit the application-revisions-documents screen and return to the applications-document-menu screen they can click on this link.

Application-Report Screen

The application-report screen is a special kind of content screen that usually appears after a Project has been completed. It usually contains a representation of the results that have been collected during the completion of the Project.

The format of the report has no set structure, in order to allow for maximum flexibility.

Reports must be able to be generated as HTML pages for viewing online or as PDF documents. Use of XML as the underlying architecture makes this a relatively simple task by utilising XML-PDF XSL transformations.

It will be necessary for a single Application to be able to support multiple reports and at arbitrary points throughout the Decision Tree. For example, in addition to a final report that summarises inputs to questions, there may need to be several intermediary ‘reports’ that are viewable before completion of the questions. In addition, several different versions of output reports may need to be available for each Application.

Several general types of report format have been specified:

Audit report—represents answers to questions, and is used to report the results of the process for auditing processes (to record the process).

Action report—to give the owner of the process an action list based on their responses

Approval report—to allow a supervisor to sign-off on a process or the results of the process

Request for service—to assist with detail in a request for service or advice from a third part (e.g. advertising firm being requested to make changes to a proposal).

Proforma—doesn't represent answers to questions, but forms a document that may be an application form, or a template for a contract, based on answers to questions.

Administration Interface Functionality

This section details the operation of the Administration Interface functionality. Although some suggestions for the layout and appearance of the Administration Interface are made for illustrative purposes, many variations are possible. This section begins with an overview of what the Administration Interface does, followed by details on how it functions.

Overview of the Administration Interface

The Administration Interface is designed to allow authorised administrators to do four basic things: manage lists of Users for an Application, manage the contents of Questions in an Application, access the details of Projects in an Application, and view logs of User activity for an Application.

The Administrator begins by logging in to the Administration Interface via a login screen that requires them to input their login name and a secret password.

After logging in, the Administrator proceeds to an Administration Menu screen listing the current management options that are available. Depending on what level of Administration access an Administrator has been granted, they may have access to only some of the available options.

The list of available options for an Administrator will be made up of one or more of the following:

Administer Users and Groups

Edit Question Contents

Open Projects

Access User Logs

The Administrator's selection of one of these options on the Administration Menu screen will determine their next point in the Administration Interface.

Administrator Groups and Privileges

In the preferred embodiment, there are five ‘levels’ of Administration access, and these are represented by five special Administrator Groups that are built in to the System. Membership to one or more of these Groups determines which, if any, parts of an Application a User may access (A User is referred to as an Administrator if he or she belongs to one or more of these Groups). The five Groups and their respective privileges are detailed below:

Root Administrator Group—members of this Group have the highest level of access privilege in the System. They have access to all management options in the Administration Interface. Members of this Group have the privileges of all other Groups, and in addition, are able to add new Administrators and/or modify the details of other Administrators.

User Administrator Group—members of this Group have access to the “Administer Users and Groups” option of the Administration Interface. User Administrators may edit details of Users and assign Users to Groups, except that they may not edit details of any other Administrators, or add Users to any of the Administration Groups.

Question Administrator Group—members of this Group have access to the “Edit Question Contents” option of the Administration Interface, allowing them to modify the question contents for an Application.

Project Administrator Group—members of this Group have access to the “Open Projects” option of the Administration Interface, allowing them to view and/or edit the data entered for any Project within an Application.

Log Administrator Group—members of this Group have access to the “Access User Logs” option of the Administration Interface, allowing them to view logs of all User activity for an Application.

Administration Interface Screen Structure

The Administration Interface screen is made up of a single frame that encompasses the entire browser window. Unlike the User Interface, the Administration Interface screen structure does not have multiple operating states (such as “open” and “closed”). The frame for the Administration Interface is called the “administration frame”. The contents of the administration frame depend on inputs and selections made by the Administrator.

The Interface is generated via XML-XSL transformations, whereby textual content for the interface is stored in the Administration Interface XML file, and instructions on which parts of the interface are presented, and how, are included in the Administration Interface XSL document.

The entire interface is comprised of three basic kinds of Administration Interface screens (but note that the XML implementation is designed to allow for new types to be added as required). The purpose of having different screen types is to allow for a variety of formats within a single interface. For example, a login screen has a different format to an error message.

Each time the Administration Interface is accessed it will be passed information on the Administrator's position in the interface and status via embedded HTML form variables. The Administration Interface XSL document uses the embedded information to determine which screen type to display at what times.

The Administration Interface XML file contains only information about the layout and appearance of each screen type. It is effectively a template for each screen type. The actual content for each screen is drawn from either the XSL document (in the case of reporting an error, for example), other components (in the case of generating a menu of options, for example) or the Question Content XML file (in the case of presenting a question).

Administration Interface Screen Types

The following are sample screen types:

login—a template for presenting the login screen when a user first accesses the Administration Interface.

administration—a set of templates for the contents of the administration frame, which contains content, menus, and reports presented as the Administrator progresses through the interface. There are quite a number of administration frame templates, because there are a number of states that the administration frame can be in, each state performing a different task.

message—a template for presenting system messages such as error messages.

Accessing the Administration Interface

Administrators access the interface with a URL that references the Administration Interface indirectly via the Security Manager servlet on the System. Different areas of the interface are accessed by posting HTML Form variables to the Security Manager. For example, form variables are used to indicate which Application is identified, the Administrator's identity, etc. After authorising a request, the Security Manager passes appropriate form variables on to the Transformation Engine. These are then available for the Transformation Engine to use when generating the response from Administration Interface XML and Administration Interface XSL documents.

At a minimum, each request to the Administration Interface via the Security Manager must specify an Application, and an Administration Request flag. An Administration Request flag is simply a form variable with a name-value pair that specifies “admin=yes”. When this variable is included in any request, the Security Manager will treat the request as a request to access the Administration Interface, rather than the default User Interface for an Application.

When accessing the Administration Interface for the first time in a session, the Security Manager component will normally be called by simply appending a question mark character followed by the Application Name, then the text string “&admin=yes” to the end of the URL. For example, if the URL to refer to the Security Manager were

“http://lotj.com.au/servlet/com.lotj.marketeer.Secure”,

then to access the Administration Interface for an Application called “Sample-Questions”, the full URL would be:

“http://lotj.com.au/servlet/com.lotj.marketeer.Secure?Sample-Questions&admin=yes”.

If the Administration Interface is being used to access an Application for the first time, the System will need to create the necessary database structures representing the Application. Recall that a new Application can be added in the System simply by adding a new subdirectory under the Applications Directory. It is up to the System to create the necessary entries in the Application Information Table representing the new application. The main purpose of this is to create an internal identifier for the Application that links other information (such as Project information) to particular Applications.

Authentication for the Administration Interface

When the Administration Interface is accessed for the first time in a session, the user will be prompted to log in by submitting their login name and a password via an HTML form. This form will also have embedded in it hidden variables that contain the Application name and also the Administration Request Flag.

After submitting their details, they are checked against the User Profiles database tables. In order to be granted access to the Administration Interface, the User must be a member of at least one of the Administration Groups.

If the Administrator's login details are valid, the Security Manager generates a random string of characters for the Administrator as a Session Key. This Session Key is subsequently embedded as an HTML form variable in all future requests made by the same Administrator in the same session.

The Security Manager maintains an internal record of all currently valid Session Keys, along with the details of the Administrator to whom the key belongs. The internal record of the Administrator's session Key includes a reference to the Administration Group(s) that the Administrator belongs to. This information is checked by the Security Manager upon every subsequent request to the Administration Interface, to ensure that the Administrator has permission for all attempted actions.

Session Keys become invalid after a specified period (e.g. 30 minutes) of inactivity (i.e. no requests to the Administration Interface being made). This effectively logs the Administrator out of the system after 30 minutes of inactivity as an added security precaution and to efficiently manage internal memory resources.

If the user accesses the Administration Interface and the accessing request does not include either a valid Session Key or login details, the user will be presented with a login screen. This is a different login screen to the User Interface Login Screen.

Administration-Menu Screen

The administration-menu screen is the first screen presented to the Administrator after successfully logging in to the Interface. The screen lists the options that the Administrator has for managing the state of the specified Application. A sample layout for the administration-menu screen 200 is shown in FIG. 17 and has the following components.

header 201—header text to identify the Application that has been specified in the accessing URL

title 202—a title for the page

description 203—explanatory text for the screen options and functions.

control area 204—an area of the screen in which the Administrator is able to send input to the System via the Administration Interface.

menu list 205—the main purpose of the control area on this page is to provide a list of management options in a menu format. The menu list provides hyperlinks or buttons that, when clicked, send the Administrator to the relevant operation screen.

Through the Administration-menu screen, the administrator may perform known administration tasks such as manage users and groups, logins, access permissions etc.

Administration-Questions-Edit Screen

The administration-questions-edit screen is presented to the Administrator if they select the “Edit Question Contents” link on the Administration Menu. This screen provides controls embedded in a java applet, to manage the question edition process. In the control area of the Administration-questions-edit screen, a question editing Java Applet is displayed. The Question Editing Java Applet is provided to give Users a basic graphical tool to assist in the creation and management of questions within the current Application. A Java Applet is used here to provide a richer graphical interface and faster updates of information entered by the Administrator.

When the administration-questions-edit screen is accessed, the Applet is initialised with the current contents of the Decision Tree.

The Java Applet is comprised of two panels laid out in two vertical columns. In the left column of the interface, the current Decision Tree structure is represented graphically.

The decision tree is represented as a single collapsible list whereby sections and subsections are represented via indented lists. Making the list collapsible means that whole sections or subsections can be ‘opened’ or ‘closed’ to show or hide their contents, respectively. The ability to show and hide sections and subsections makes the hierarchical Decision Tree structure easier to navigate.

If a section in the Decision Tree is in a closed state, it will appear with a plus sign beside it. Clicking on the plus sign will cause the list to be refreshed with the section in an open state.

Is a section in the Decision Tree is in an open state, it will appear with a minus sign beside it. Clicking on the minus sign will cause the list to be refreshed with the section in a closed state.

In the Decision Tree representation, one or more list items can be selected by clicking on a single list item or by dragging the mouse over a number of items.

The right column of the Java Applet contains buttons for selecting editing operations (question edit controls), and an area for presenting the details of selected items (item detail controls).

When a single item is selected in the Decision Tree representation, the details of the item are displayed in the item detail controls. If the selected item is a section, then section details will be displayed. If the selected item is a question, then question details will be displayed.

If multiple items are selected in the Decision Tree representation, the item detail controls area becomes inactive.

The question editing operations include “Add Question”, “Add Section”, “Edit”, “Delete” and “Preview”.

If “Add Question” is pressed, the item detail controls area refreshes as an empty template into which the details of a new question can be entered. If one or more items are selected and the last item in the selection is a question, then the new question is appended after the last item in the selection. If one or more items are selected and the last item in the selection is a section, the question will be appended after the last question in that section. If no items are selected, then the new question is appended after the last question in the Application.

If “Add Section” is pressed, the item detail controls area refreshes as an empty template into which the details of a new section can be entered. If one or more items are selected in the Decision Tree representation, and the last item selected is a question, then the new section will be added after the last item in the selection. If one or more items are selected and the last item in the selection is a section, then the new section will be added as a subsection of that section. If no items are selected, the new section is appended at the top of the Decision Tree hierarchy, after any other top-level sections.

The “Edit” button will only be accessible when a single item is selected in the Decision Tree representation. If “Edit” is pressed, then the item detail controls area refreshes to contain an editable template into which the details of the selected item can be entered.

If “Delete” is selected, then a confirmation dialog appears in the item detail controls area asking the Administrator to confirm that they wish to delete the selected items. If the Administrator confirms the action, then the selected items will be deleted from the Decision Tree structure. If one or more sections are selected, then they can only be deleted if all items within the section are first deleted.

If “Preview” is pressed, then a new browser window will open that shows the content of questions as they will appear to users via the User Interface. If one or more items are selected when preview is pressed, then the preview will begin with the first question in the selection. If no items are selected when preview is pressed, then the preview will begin with the first question in the Application.

Administration-Projects Screen

The administration-projects screen is presented to the Administrator if they select the “Open Projects” link on the Administration Menu.

The screen provides a list of all current Projects that have been created in the Application, and allows the Administrator to jump in to the User Interface for any of those projects. The control area of this screen allows the Administrator to send input to the System via the Administration Interface. For this screen the main purpose of the control area is to display the projects list. The Projects list is a list of all Projects for the current Application. Each project is listed by name, description, owner and date of last modification. The name of each project is presented as a hyperlink. Clicking on this hyperlink will allow the Administrator to directly enter the selected Project via the normal User Interface for the Application.

In a further modification of the preferred embodiment, there can be provided a task allocation tool of allocating tasks.

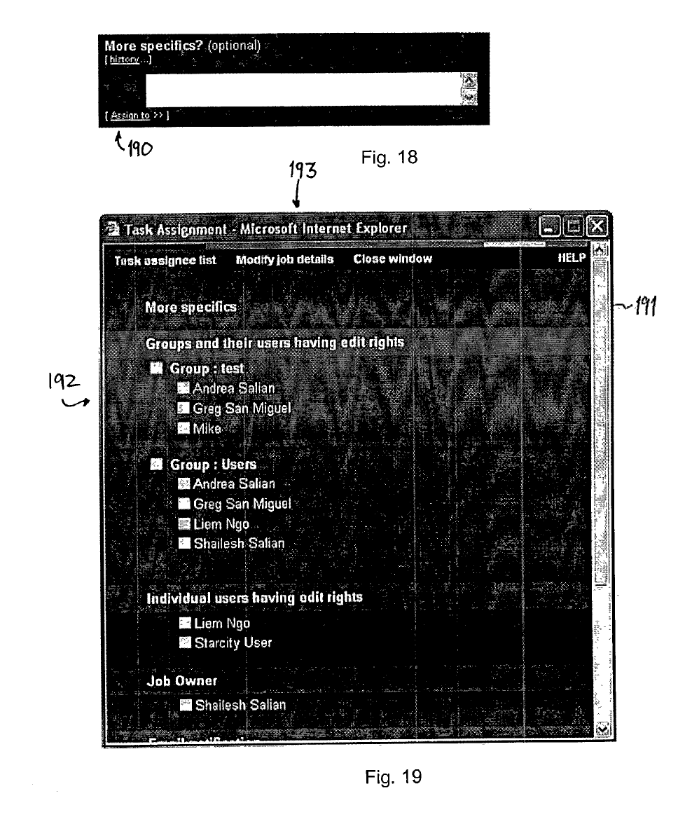

If the user has edit rights to the project then the user can assign task on a particular question in that project to a single or group of users who also has edit rights to the project. Ideally, as illustrated in FIG. 18, a link to assign task 190 appears below each question and clicking on the link opens a task assignment dialog box 191 as illustrated in FIG. 19. The Task Assignment Dialog box displays a series of questions including a list of users having update rights to the project (‘edit list’) 192 from which the user selects the assignee. If the user needs to assign a task to users not named in the edit list, the user may modify project details 193 [via direct link from the Task Assignment Dialog box] provided they have rights to modify project details and add/remove users to the edit list, and return to the Dialog box to continue the Assignment.

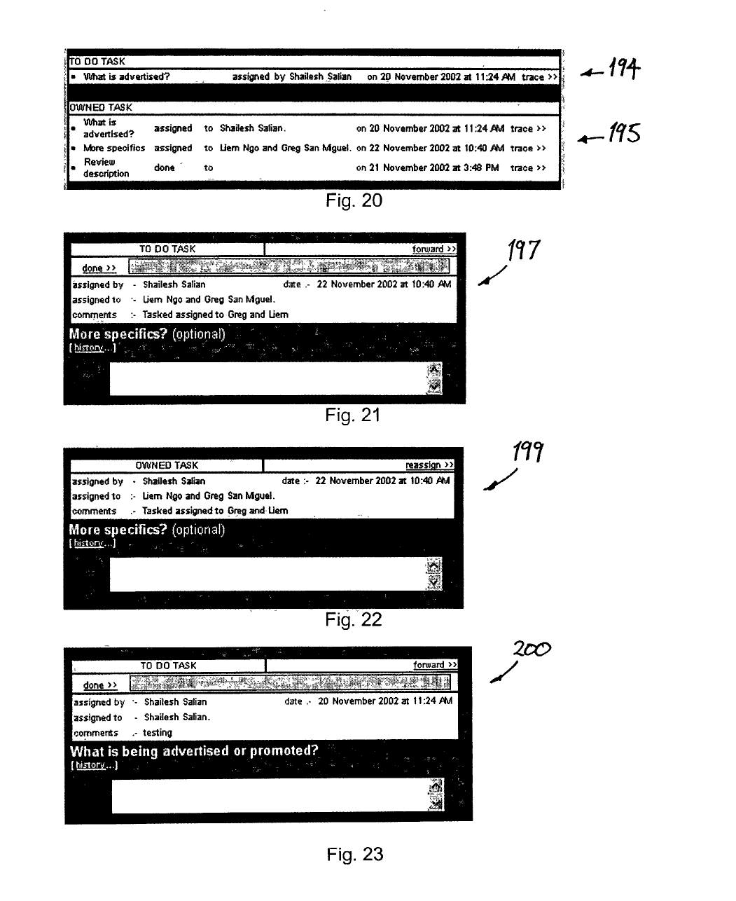

In assigning a task the user may also insert a reference comment. The user who initiates the task is the owner/assigner of the task. The user to whom the task is assigned is the to-do user/assignee of the task. Once the task is assigned, the task assignment is marked at the top of the Report, in a color coded table. As illustrated in FIG. 20, by going to the report the user can view the list of tasks owned by him/her and the list of tasks been assigned to him/her as a summary. The first table 194 which can have a read border represents ‘todo tasks’. The second table with the green border 195 represents ‘Owned task’. On the report clicking on each task in the list will take the user to the question on which the task had been initiated. Just above the question will be a box detailing the task. All the users having read-only or edit right to the project can view the task box above the question. As illustrated in FIG. 21, if the user is the assignee of the task then the box 197 can be in red border. As illustrated in FIG. 22, if the user is the assigner then a green border provided on the task 199. As illustrated in FIG. 23, if the user has assigned to self then red border appears on the task 200. If the user having edit rights has entered the project in read-only mode because the project is locked by another user then the box can have a yellow border irrespective of the user being an assigner or an assignee. If a user has only read-only rights to the project then the box will appear in yellow border. A task with yellow border represents inactive state i.e. the task is not editable.

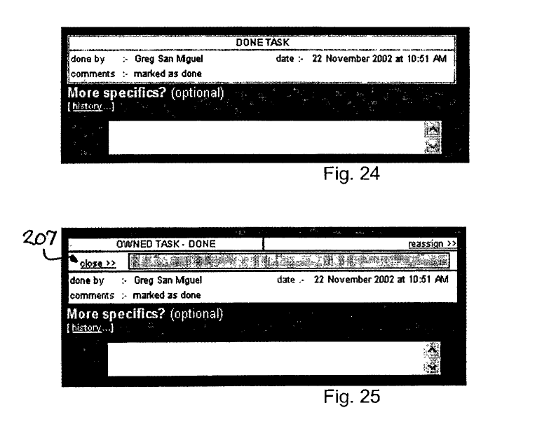

The assigner can choose to reassign the task to some other user before the assignee marks the task as done. The assignee of the task can mark the task as done by clicking the ‘done’ link e.g. 205 of FIG. 21, and writing a communicative comment to the assigner. The assignee can also choose to forward the task to some other user if needed. During the assignee's session once the task is marked done it disappears from the assignee's report and remains over the question with yellow border marked ‘done task’ as shown in FIG. 24 for the assigner to review the task. The done task is appropriately flagged as done in the assigners report from where the assigner can jump to the question on which the task was assigned. If the assigner enters the project which is still locked by some other user then the task box over the question will have yellow border and will be non editable even though the assigner is the owner of the task. If the lock on the project is released then the assigner can view the box in green border and a status showing ‘Owned task—done’.

In the reporting section, the assigner can view the life cycle of the task as it propagates through the system. The assigner can choose to close or reassign the task to some other user based on the review. To close the task, as shown in FIG. 25, the assigner has to click on ‘close>>’ link 207 and include his/her comments whereby not only it would disappear from the report as well as from the top of the question. Once the task is closed the task would appear in the job history above the question on which it was assigned as an item in the list of closed tasks. While assigning, reassigning or forwarding the task the user can choose on the option to send email. When this option is checked a cc of that email will go to the assigner and the job owner. At any given time there can only be one task open for a question. When a task is open for the question the ‘assign to>>’ link will disappear and will only appear once the task is closed.

Such a system provides for an intuitive assignment of tasks to a collection of users so as to ensure the overall completion of a project.

Throughout this specification the word “comprise” and variations of that word, such as “comprises” and “comprising” are not intended to exclude other features, additives, components, integers or steps but rather, unless otherwise stated explicitly, the scope of these words should be construed broadly such that they have an inclusive meaning rather than an exclusive one.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive and all such modifications and/or variations are intended to be embraced herein.

1. A method of increasing the compliance level and management of a plan of action, the method comprising the steps of:
(a) providing an interactive browser environment for users associated with said plan of action to undertake an analysis of a corporation's policies, laws, regulations or standards associated with the operation environment for said plan of action, and
(b) providing via said browser a series of questions and associated information directed to a corporation's policies, laws, regulations or standards associated with the operation environment for said plan of action.

2. A method as claimed in claim 1 further comprising the step of:
(c) providing a task setting mechanism within said browser environment for setting of tasks for completion by uses associated with said plan of action.

3. A method as claimed in claim 1 wherein said series of questions include a series of structured checkpoint questions posed in the interactive browser environment for asking a series of checkpoint questions about the plan of action, said checkpoint questions identifying various legal and regulatory issues that may impact on the plan of action;

4. A method as claimed in claim 1 wherein first predetermined members of said series of questions have associated interactive advisory prompts for users to review in answering the questions.

5. A method as claimed in claim 1 wherein second predetermined members of said series of questions have associated interactive task creation facilities for creating tasks associated with the questions for users of said system to perform.

6. A method as claimed in claim 5 wherein said task creation facilities include task designation and sign off capabilities for assigning tasks to users and ensuring their completion.

7. A method as claimed in claim 2 further comprising the step of:
(d) providing a task reporting facility for reporting allocated tasks associated with a project.

8. A method as claimed in claim 1 further comprising the step of storing substantially all the user's interactions with the system for future reference of procedural compliance.

9. A computer based interactive training system for just in time training of individuals involved in a currently active project, the system including:
(a) an interactive user interface;
(b) questioning means for asking an interactive series of questions through the user interface, with the user's answers recorded by the system and determining what future questions may be asked by the system with predetermined members of said series having associated background information on compliance issues associated with said question;

10. A system as claimed in claim 9 further including:
task setting means for task setting capabilities for setting and monitoring tasks for completion by users of said system.

11. A system as claimed in claim 9 wherein said series of questions are directed to a corporation's policies, laws, regulations or standards and said system acts to increase compliance with said corporation's policies, laws, regulations or standards.

12. A system as claimed in claim 9 wherein said system is implemented utilising Web Browsers and XML and XSL documentation standards.

13. A system as claimed in claim 10 wherein different users have different capabilities in the setting of tasks for other users.

14. A system as claimed in claim 9 wherein substantially all user interactions with the system are stored for future reference of procedural compliance.

15. An interactive project monitoring system comprising:—
a question database;
a response database;
a user interface;
one or more applications;
wherein said question database stores a plurality of system questions in a structured decision tree of questions and wherein said user interface provides a selected application to an authenticated user; wherein a user is able to create a project through said interface, said project comprising a plurality of user provided responses to the questions of an application; and wherein said user provided responses are stored in said response database.

16. A system according to claim 15 wherein a project comprises references to standard answers stored in the response database.

17. A system according to claim 16 wherein if a user provided response to a question does not exist within the response database, the system writes the new response into the database and stores a reference to the response within the project, otherwise, a reference to the existing response is stored within the project.

18. A system as claimed in claim 15 further comprising a reference database containing reference data, wherein an application contains one or more links to reference data in said reference database that is relevant to the application, said links being selectable by the user through the interface to cause said user interface to display said selected reference data.

19. A system as claimed in claim 15 further including an administration interface through which an administrator may alter content of the system.

20. A system as claimed in claim 15 wherein each application decision tree comprises one or more sections selectable by an authenticated user through the user interface, each section comprising one or more subordinate pages, each page comprising one or more questions from said question database, wherein pages are presented through the user interface in a sequential order according to a control logic dependent upon user provided responses to page questions.

21. A system according to claim 20 wherein one or more pages contain a hyperlink to reference material relevant to the content of the respective page.
